(19) United States
(12) Patent Application Publication
(10) Pub. No.: US 2006/0269057 A1
(43) Pub. Date: Nov. 30, 2006

(54) Systems and methods for high resolution signal analysis and chaotic data compression

(75) Inventors: Kevin M. Short, Durham, NH (US); Ricardo Garcia, Somerville, MA (US); Michelle Daniels, Arlington, MA (US); John Curley, Gorham, ME (US)

Correspondence Address: FISH & NEAVE IP GROUP;ROPES & GRAY LLP, ONE INTERNATIONAL PLACE, BOSTON, MA, 02110-2624, US

(73) Assignee: Groove Mobile, Inc., Andover, MA (US)

(21) Appl. No.: 11/441,791

(22) Filed: May 26, 2006

Related U.S. Application Data
(60) Provisional application No. 60/685,763, filed on May 26, 2005.

(51) Int. Cl. H04N 7/167

(52) U.S. Cl. 380/228

(57) ABSTRACT

Systems and methods for processing, compressing, and distributing data, such as an audio file, are provided. Single- and multi-channel data streams are transformed into a single signal in a Unified Domain. A high resolution frequency analysis based on phase evolution provides accurate frequency estimates and distinguishes between oscillatory and noise-like signal components. The unified signal components are then prioritized using a Psychoacoustic Model. The prioritized components can be arranged in layers based on the component priorities and compressed (e.g., with a chaotic compression scheme). The least psychoacoustically important layers can be removed to lower the transmission bitrate. Digital rights management tools based, for example, on a unique device identification can be used for secure distribution.

### CROSS-REFERENCE TO OTHER PATENT APPLICATIONS

This application claims the benefit of U.S. Provisional Patent Application No. 60/685,763, filed on May 26, 2005, the contents of which are hereby incorporated by reference herein in their entirety.

### FIELD OF THE INVENTION

This invention relates to front-end processing of complex signal spectra to detect the presence of short-term stable sinusoidal components in the spectra with improved frequency resolution and, more particularly, to use the detected components for data compression with chaotic systems.

### BACKGROUND OF THE INVENTION

Compression techniques for data have been developed. Such techniques reduce the number of bits required to represent the data such that the data may be easily stored or transmitted. When the data is desired to be utilized, the data is decompressed (i.e., reconstructed) such that the original data or a near approximation of the original data is obtained.

Different data compression schemes have been developed for specific types of data. Using transmission of audio data as an example, traditional transform-based codecs are computed for a certain bitrate and different codecs need to be provided depending on the desired or available transmission bitrate. Stated differently, traditional transform-based codecs are not scalable, in that the transform-based codecs have to be modified in order to obtain different bitrates. Psychoacoustic models have been utilized to quantize coefficients of time-frequency transforms and to quantify. The psychoacoustic model provides for high quality lossy signal compression by describing which parts of a given digital audio signal can be removed (or aggressively compressed) safely—that is, without significant losses in the quality of the perception of sound by humans. It is therefore desirable to develop systems and methods for data compression and distribution that achieve high compression ratios while allowing for scalability from low bitrates to higher bitrates to lossless formats. It is also desirable to provide pre-compression signal processing systems and methods that may be advantageous to a number of codecs, including traditional codecs.

Reduced-quality audio data has been distributed to mobile devices such as mobile phones and Personal Digital Assistants (PDAs). Traditional mobile devices, however, have limited storage space, processing power, and battery life. It is therefore desirable to provide systems and methods which lower the complexity of the data decoding process in the device and thereby reduce memory space and the number of processing clock cycles to reduce battery drain. It is further desirable to provide a software-only decoder that can be utilized in such traditional mobile devices.

The distribution of such audio data is traditionally protected by first verifying that payment for the audio data has been authorized. When this is properly implemented, previously distributed audio data may be transferred from one mobile device to another mobile device as long as the second mobile device is properly authorized. It is therefore desirable to provide systems and methods that can deliver high quality audio data at low bitrates with improved digital rights management tools.

### SUMMARY OF THE INVENTION

A data compression codec with a very fine frequency resolution is provided that may be utilized with any type of data such as, for example, audio, image, and video data.

The data compression codec includes a number of pre-processing steps that can be utilized with any type of compression or signal processing system, including a chaotic-based compression system.

One such pre-processing step is a lossless transformation that converts a multi-channel signal into a Unified Domain. When in the Unified Domain, the multi-channel data signal is represented as a single channel of data. As a result, a signal in the Unified Domain can be processed as a whole, rather than separately processing the individual channels. Even though a signal is transformed into the Unified Domain, all of the signal's information about the magnitudes, frequencies, and spatial locations of the signal components is retained. The transformation is an invertible technique such that a signal in the Unified Domain can be reverted back to a multi-channel signal (e.g., a surround signal).

In the high-resolution frequency analysis, the phase evolution of the components of a signal is analyzed between an initial sample of N points to a time delayed sample of N points. This analysis can be performed in the standard (single-channel or multi-channel) domain or in the Unified Domain. From this comparison, a fractional multiple is obtained that is representative of the spectral location where the signal components actually appear. As a result, the correct underlying, or dominant, frequencies for the signal can be determined. The corrected frequency information can be utilized to re-assign signal power in the frequency bins of the transform utilized to obtain the high-resolution frequency analysis.

A signal in the Unified Domain, as in the standard domain, can be decomposed into discrete components such as steady tones, noise-like elements, transient events, and modulating frequencies.

A unified psychoacoustic model of a signal in the Unified Domain is also provided. Such a model can be utilized to prioritize and quantize the components of the signal. In doing so, a scalable architecture is provided where the least acoustically important components can be removed to lower the bitrate of the signal. Accordingly, an audio delivery system may be provided that can deliver audio having different bitrates and quality without having to store multiple versions of the same audio file. A delivery system can, for example, determine a desirable or feasible transmission quality and/or bitrate to a device such as a laptop or wireless telephone and transmit only those layers of the signal (e.g., by removing layers from the complete data file) that correspond to the desired quality and/or bitrate. The remaining (missing) layers can be transmitted to the device at a later time when bandwidth becomes available.

Digital rights management tools are also provided. Here, unique identifying information is provided to an encoder. This unique identifying information is then fed into an encryption scheme in order to “lock” the compressed file so that the file can only be played on the mobile device with a decoder associated to the unique identifying information. At the decoder, the unique identifying information is utilized to decrypt the data. The received data may include, in addition to the data representative of the delivered media (e.g., images, audio, software, games, or video), meta-data associated with the delivered media. For example, the meta-data may be the artist's name, album, song title, internet link to album art, file size, transmitting entity, content provider, duration of song, and content expiration date.

At the center of the compression method is a chaotic system that utilizes an initialization code to generate a sequence of bits. Controls are intermittently applied to the chaotic system to manipulate the system to generate a number of bit strings, or waveforms in the continuous case. The data that is desired to be compressed is then compared to these bit strings, or waveforms, until a matching string is found. If a single matching string, or waveform, cannot be found, multiple strings, or waveforms, can be combined to create a matching n bit, or n-sample, portion of the data. Once all the data strings that make up the data to be compressed are replaced, the original data is discarded and the control bit strings used to generate the matching data are stored as the compressed data file. On the decompression side, the controls are applied to a similar chaotic system (e.g., a similar chaotic system located in a wireless telephone) such that the original data is generated by the system.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is a flow chart of an exemplary chaotic-based compression process constructed in accordance with the principles of the present invention;

FIG. 2 is a flow chart of an exemplary signal processing, compression, and distribution process constructed in accordance with the principles of the present invention;

FIG. 3 is an illustration of an exemplary scalability process constructed in accordance with the principles of the present invention; and

FIG. 4 is a flow chart of an exemplary transformation of a multi-channel signal to a signal in the Unified Domain process constructed in accordance with the principles of the present invention;

FIG. 5 is a flow chart of an exemplary high resolution frequency analysis process constructed in accordance with the principles of the present invention;

FIG. 6 is a flow chart of an exemplary signal synthesis process using cupolets in accordance with the principles of the present invention;

FIG. 7 is a flow chart of an exemplary frequency mask derivation process constructed in accordance with-the principles of the present invention;

FIG. 8 are illustrations of high-resolution frequency-domain analyses of signals processed by systems and methods constructed in accordance with the principles of the present invention;

FIG. 9 are illustrations of synthesis of the signals of FIG. 8 with the frequency components determined in accordance with the principles of the present invention;

FIG. 10 is a flow chart of an exemplary digital rights management process constructed in accordance with the principles of the present invention;

FIG. 11 is an illustration of an exemplary mobile device constructed in accordance with the principles of the present invention; and

FIG. 12 is an illustration of an exemplary network topology constructed in accordance with the principles of the present invention;

### DETAILED DESCRIPTION OF THE INVENTION

For a better understanding of the invention, reference is made to U.S. patent application Ser. No. 10/099,812 filed on Mar. 18, 2002 and entitled “Method and Apparatus for Digital Rights Management and Watermarking of Protected Content Using Chaotic Systems and Digital Encoding and Encryption”, U.S. patent application Ser. No. 10/106,696 filed on Mar. 26, 2002 and entitled “Method and Apparatus for Chaotic Opportunistic Lossless Compression of Data”, U.S. patent application Ser. No. 10/794,571, filed Mar. 6, 2004 and entitled “Methods and Systems for Digital Rights Management of Protected Content”, and U.S. patent application Ser. No. 11/046,459 filed on Jan. 28, 2005 and entitled “Systems and Methods for Providing Digital Content and Caller Alerts To Wireless Network-Enabled Devices”, the entire contents of which are hereby incorporated by reference herein in their entirety.

The invention is directed to systems and methods suitable for analyzing and detecting the presence of short-term stable sinusoidal components in a signal, in particular an audio signal. The methods are robust in the presence of noise or nearby signal components, and represent an important tool in the front-end processing for compression with chaotic systems. However, the systems and methods can also be employed with other data compression approaches.

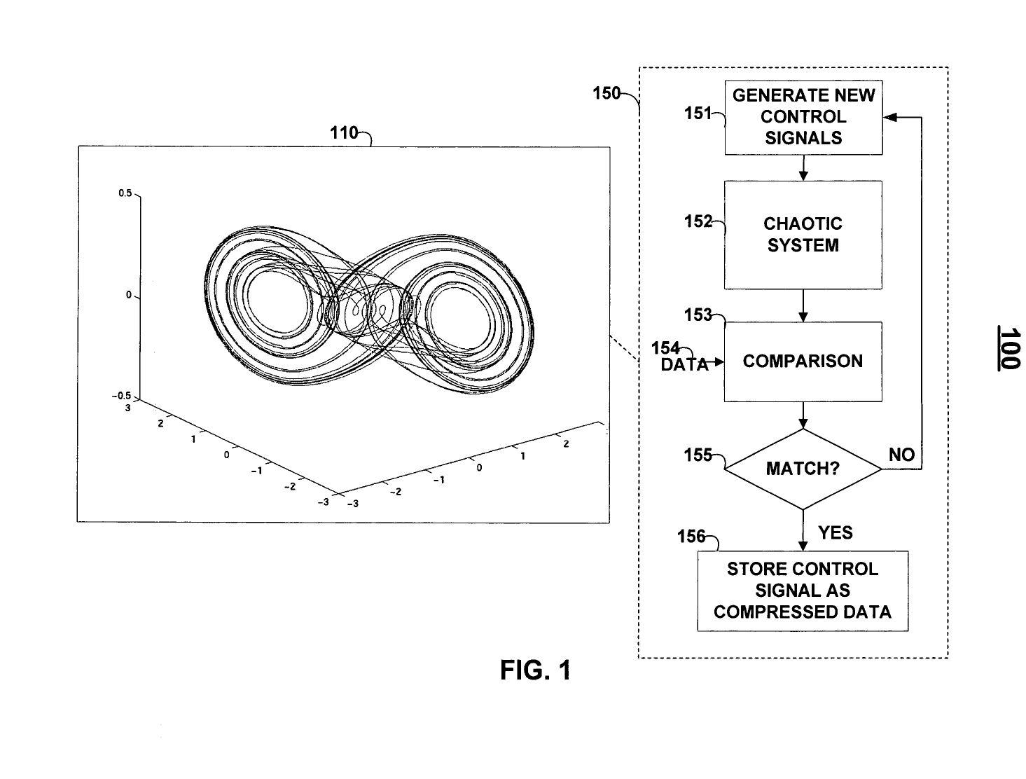

FIG. 1 shows chaotic system 100 that includes output set 110 from a chaotic-signal generator, such as a double scroll oscillator (not shown), and that can perform the steps of flow chart 150. Generally, the compression system is accomplished through the controlled use of chaotic systems. Particularly, control signals can be utilized in chaotic systems to induce the chaotic systems to settle onto periodic orbits that would otherwise be unstable (e.g., aperiodic). The control signal may be relatively small in length (e.g., approximately 16 bits), but the resultant periodic waveforms can include more than 200 harmonics in their spectrum. The difference in size between the control signals and the resultant waveforms may be utilized to create a compression scheme with a compression rate similar to the size relationship of the two signals.

Waveforms produced by the chaotic signal generator may be, for example, cupolets. Cupolets naturally carry structures present in speech and music signals. Accordingly, cupolets can be used individually, or combined with one another, to model such speech and music signals.

One type of chaotic signal generator is the double-scroll oscillator which may be defined by, for example, the following set of nonlinear differential equations that form a 3-variable system.

$${C}_{1} \frac{ⅆ {V}_{C 1}}{ⅆ t} = G ( {V}_{C 2} - {V}_{C 1} ) - g ( {V}_{C 1} )$$

$${C}_{2} \frac{ⅆ {V}_{C 2}}{ⅆ t} = G ( {V}_{C 1} - {V}_{C 2} ) + {i}_{L}$$

$$L \frac{ⅆ {i}_{L}}{ⅆ t} = - {V}_{C 2}$$

$$where$$

$$g ( V ) = \{ \begin{matrix}{m}_{1} V , & - {B}_{p} \leq V \leq {B}_{p} \\ {m}_{0} ( V + {B}_{p} ) - {m}_{1} {B}_{p} , & V \leq - {B}_{p} \\ {m}_{0} ( V - {B}_{p} ) + {m}_{1} {B}_{p} , & V \geq {B}_{p}\end{matrix}$$

Here, g(V) represents a nonlinear negative resistance component, and C₁, C₂, L, G, m₀, m₁, and Bₚ are constant parameters. These equations can be used to build an analog circuit, digital circuit, or the equations can be simulated on a computer as software. For example, a programmable logic device may be utilized to embody the equations in hardware. If a circuit is built, the variables V_{C1} and V_{C2} may be voltages, and i_{L} may be a current. In the equations, the variables may be real and continuous, while the output of a software simulation may produce a sampled waveform.

A chaotic system such as, for example, a double-scroll oscillator, may settle down to, and may be bounded by, an attractor. The system may regularly settle down to the same attractor no matter what initial conditions were used to set the system. In the 3-variable system provided by the above equations, these attractors are usually ribbon-like structures that stretch and fold upon themselves and remain confined to a box. The actual state of the 3-variable system may be determined by the instantaneous value of the system variables, V_{C1}, V_{C2}, and i_{L}. The values of these variables preferably may never repeat such that an aperiodic system may be provided.

While the chaotic attractors are aperiodic structures, the attractors can have an infinite number of unstable periodic orbits embedded within them. The control signals may be provided to stabilize these orbits by perturbing the state of the system in certain fixed locations by a particular amount. Using the above equations as an example, the attractor that results from a numerical simulation using the parameters C₁= 1/9, C₂=1, L= 1/7, G=0.7, m₀=−0.5, m₁=−0.8, and Bₚ=1 has two lobes and an example of a trajectory from the system is shown as signal 110.

A control half-plane is passed through the center of each lobe and outward to intersect the outer part of each lobe. Since the attractor is ribbon-like, the intersection of the attractor with the control plane is substantially a line. When the state of the system passes through the control line, the control scheme allows perturbations, e.g., of order 10⁻³, to be applied. The controls are defined by a bit string, which may be approximately 16 bits in size, where a zero (0) bit means that no perturbation is applied at an intersection with the control line and a one (1) bit means to apply a perturbation. These controls may be applied repeatedly at intersections with the control line, and a single bit at a time may be read from the control string to determine if a perturbation is to be applied (looping back to the beginning of the control string when the last bit has been READ).

A number of the control strings may cause the chaotic system to stabilize onto a periodic orbit, and these periodic orbits may be in one-to-one correspondence with the control string used (and may be independent of the initial state of the system). By varying the control string a few bits, the chaotic signal generator can produce tens of thousands of cupolets.

Once a cupolet is stabilized, for example, the cupolet forms a closed loop that tracks around the attractor and is defined by the three state variables. The conversion to a one dimensional waveform can be done in a circuit implementation by taking the output of one of the voltage or current measurements. If performed in software, a digitized waveform can be produced, for example, by sampling one of the state variables. The term cupolet can be used to, for example, represent both the periodic orbit in three dimensions and the one-dimensional waveforms that it produces.

To characterize the spectra of the cupolets, the magnitude of the Fast Fourier Transform (FFT) of the associated one-dimensional waveforms of a single period of oscillation can be determined. This single-period spectral representation can determine the number of harmonics as well as the envelope or formant structure of the cupolet. As a result, cupolets can be utilized to produce signals by modeling the bins in the transform domain.

Flow chart 150 shows how data can be compressed using a chaotic signal generator. Previously untested control signals for the generator may be obtained in step 151. These control signals can be utilized to control a chaotic system in step 152 such that a number of cupolets are produced. These cupolets, either alone or in combination with other cupolets, may then be compared to the data that is desired to be compressed in step 154. If a match is found between the cupolets and the data desired to be compressed, then the control signal may be stored as compressed data in step 156. Additional data can also be stored as compressed data. Such information may include, for example, the information needed to select, modify, and/or combine cupolets, from the output of the chaotic system in step 152, in order to produce a resultant waveform that matches the data that is desired to be compressed. Accordingly, additional processing steps may be included such as, for example, a processing step that selects a portion of a waveform, modifies a portion of a waveform, or combines multiple waveforms (or portions of waveforms) such that a match can be obtained in step 155. If a match is not found, new control signals can be generated in step 151 and the process can be repeated.

Persons skilled in the art will appreciate that the processing speed of the encoder may be increased by pre-determining the cupolets that result from all control strings inputted into the chaotic system. In doing so, the data to be compressed can be scanned against a look-up table. When a matching cupolet is found, the control string associated to the cupolet in the look-up table may be stored as compressed data. A search of the look-up table may be performed, for example, per control signal such that combinations of cupolets for that control signal may be compared to the data to be compressed. This embodiment trades off increased memory demand against processing speed.

As a chaotic system may be provided through a small number of coupled nonlinear differential or difference equations, the complexity of a decoder is simply the complexity of processing the chaotic equations, or look-up tables, as well as certain standard DSP functions. Furthermore, nonlinear equations are not complex or difficult to process, yet generate complex behavior in the time domain as well as continuous and discrete waveforms.

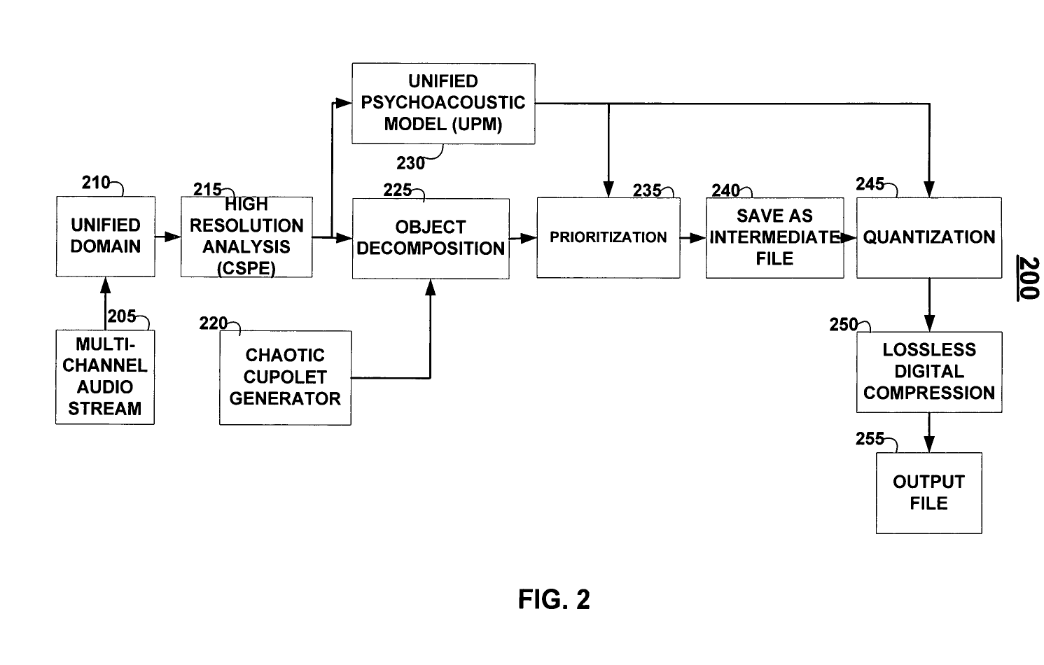

FIG. 2 is an exemplary flow diagram of a process 200 for pre-processing an audio stream to extract multi-channel frequency and phase information.

The process of 200 begins at step 205 with a multi-channel audio stream which is converted into, for example, a single channel audio stream in the Unified Domain, at step 210, by a Unified Domain transformation. This transformation may retain information about, for example, the magnitudes, frequencies, internal phases, and spatial locations of the signal components of each channel while placing the information in a single signal. The Unified Domain transformation is an invertible technique, as the single signal representation involves a single magnitude component multiplied by an element of the complex Unitary (U(N)) or Special Unitary group (SU(N)) for N-channels. The U(N) or SU(N) group can be represented in many ways. For the purposes of transforming a multi-channel signal, the structures of complex matrices are employed. In the case of stereo input, two channels are present such that N=2. Accordingly, the representation in the Unified Domain may be provided, for example, as a single magnitude component multiplied by a 2×2 complex matrix.

More particularly, the transformation of a multi-channel audio stream is represented as:
T:C^{N} [symbol] mag*SU(N)≡U^{N}
[audio_{ch0} audio_{ch1} . . . audio_{chN-1}] [symbol] U^{N}
where the magnitude is a function of frequency, N channels are input, and U represents the Unified Domain.

For a conventional two channel audio stream (such as Left/Right) the representation becomes:
[L R] [symbol] U²

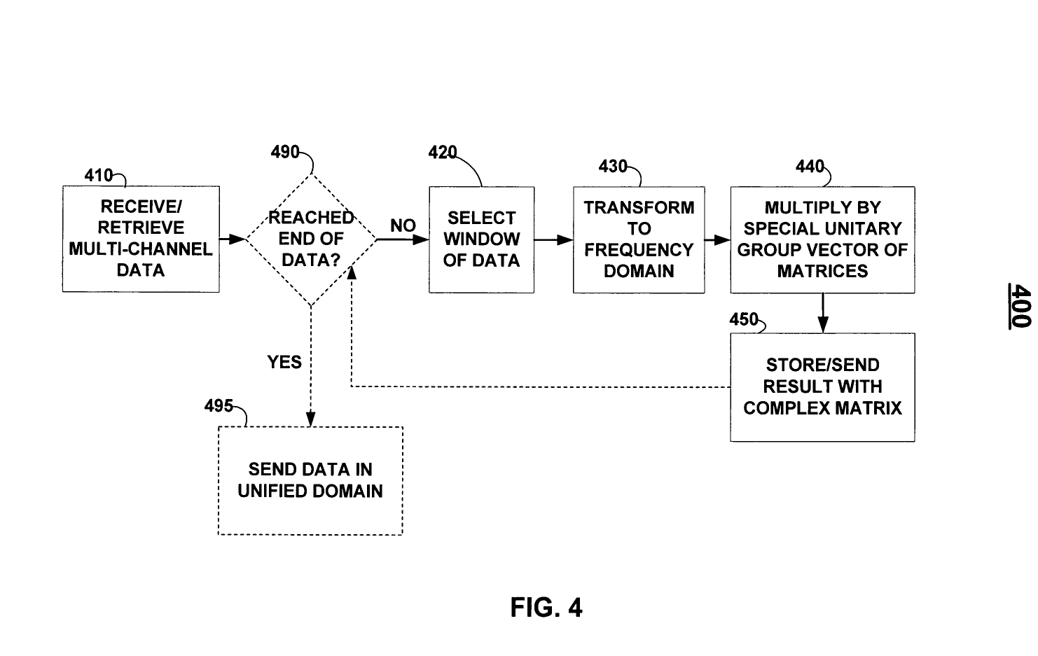

This representation is a one-to-one mapping and is lossless. Any manipulations done in one domain have an equivalent counterpart in the other domain. As such, persons skilled in the art will appreciate that a number of processing techniques may be performed on a signal in the Unified Domain that may realize advantageous functionality. For example, a process to a signal in the Unified Domain may be performed faster since the process only has to be performed once in the Unified Domain, while the process would otherwise have to be performed separately for each sub-channel. Unified Domain manipulations may also keep multiple channels synchronized. A more detailed discussion of the Unified Domain transformation is given below in connection with FIG. 4.

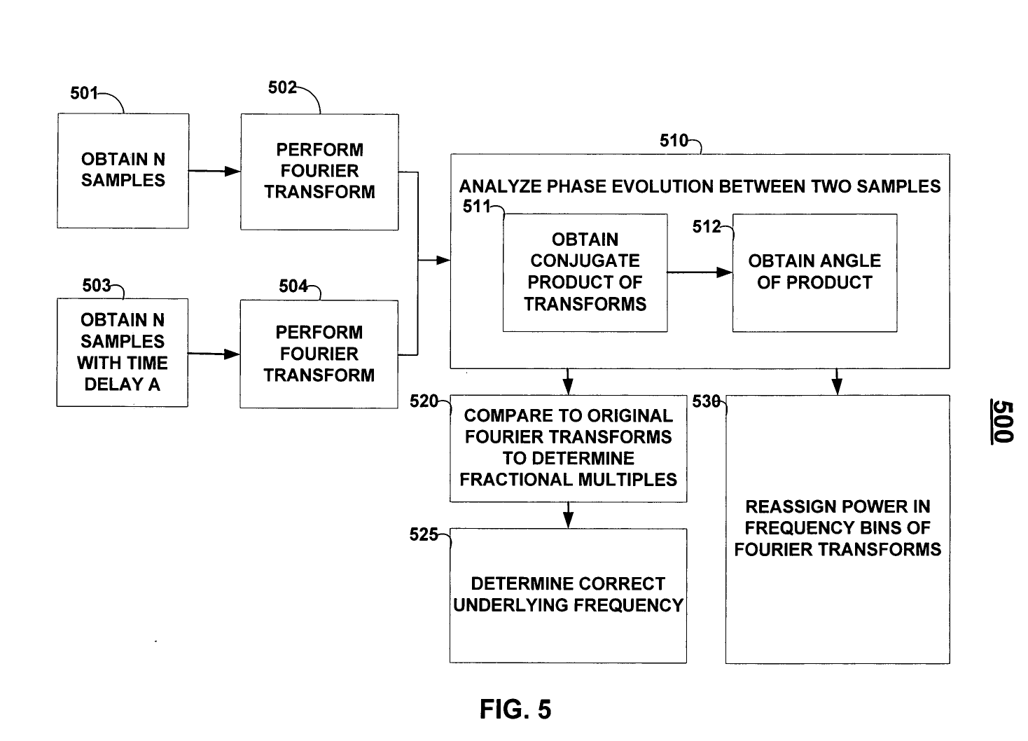

One process that may be utilized to manipulate a signal in the Unified Domain may be a high resolution frequency analysis and is included on flow chart 200 as step 215. The high resolution frequency analysis may also be referred to as a Complex Spectral Phase Evolution (CSPE) analysis. Generally, step 215 computes a super-resolution map of the frequency components of the signal in the Unified Domain. The transformation analyzes the phase evolution of the spectral elements in a standard FFT and uses this evolution to remap the frequencies to a much finer scale. As a result, the transformation can, for example, give signal accuracies on the order of 0.01 Hz for stable signals at CD sample rates analyzed in, e.g., 46 ms windows of data. The high resolution analysis of step 214 converts oscillatory signal components to line spectra with well-defined frequencies, while the noise-like signal bands do not take on structure. As such, the signal is substantially segregated into oscillatory and noise-like components. Further processing can be utilized to, for example, detect if a transient signal component is present in a frame of music or to test for, and aggregate, harmonic groupings of frequencies. A more detailed discussion of the high resolution frequency analysis is given further below in connection with FIG. 5.

Persons skilled in the art will appreciate that the process of flow chart 200 can be performed on an entire signal (e.g., an entire audio signal) or portions of a signal. As such, a windowing step may be provided at any point in flow chart 200 using, for example Hamming, Hanning, and rectangular windows. For example, frames of data may be taken directly from the multi-channel audio stream 205 or from the data in the Unified Domain (e.g., after step 210).

The data obtained from the high resolution frequency analysis can be used to prioritize the components of the signal in order of perceptual importance. A psychoacoustic model may be provided in the Unified Domain such that independent computations for each channel of data do not have to be computed. Accordingly a Unified Psychoacoustic Model (UPM) may be provided in step 230 that incorporates the effects of spectral, spatial and temporal aspects of a signal into one algorithm. This, or any, algorithm may be embodied in hardware (e.g., dedicated hardware) or performed in software.

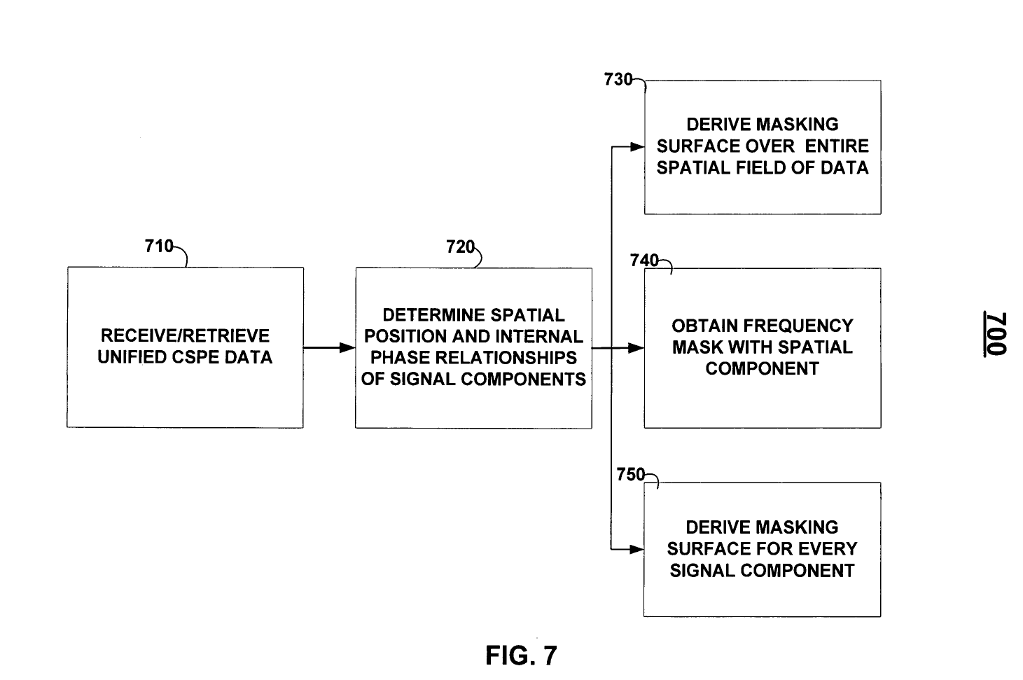

More particularly, the UPM computation may be, for example, separated into three steps. The first step may be a high resolution signal analysis (e.g., the process of step 215) that distinguishes between oscillatory and noise-like signal components. The second step may be a calculation of the masking effect of each signal component based on, for example, frequency, sound pressure level, and spatial location. Lastly, the masking effects of each signal component may be combined and projected to create a masking curve or surface in the Unified Domain. Such masking curves/surfaces may be defined locally for each signal component in object decomposition step 225 and quantization step 245. Persons skilled in the art will appreciate that the masking curves can by utilized to create a masking surface that is defined over the entire spatial field. For example, for stereo audio signals, left and right channel masking curves can be obtained with a transformation from the Unified Domain. Thus, traditional single-channel processing techniques can still be performed on a signal. At any time, a multi-channel signal can be transformed into the Unified Domain or a signal in the Unified Domain can be transformed into a multi-channel signal (or a single-channel signal) for signal processing purposes. A more detailed discussion of the UPM algorithm is discussed further below in connection with FIG. 7.

As mentioned above, step 215 produces line spectra with well-defined frequencies, while more noise-like signal bands do not take on structure. Step 225 isolates the separate signal components such that the signal can be rebuilt through, for example, an additive synthesis approach. Here, in general, bit strings and/or waveforms can be generated and one bit string or waveform, or a set of bit strings or waveforms cupolets, may be selected that have the correct spectral characteristics for the signal component being analyzed. When using a chaotic system for compression, the bit strings and/or waveforms may be so-called cupolets. Cupolets are waveforms produced by a chaotic waveform generator which can be very rich in harmonic content and require only a limited set of control codes for their definition. Cupolets can express complex signal patterns present in speech and music, and thus can be used in chaotic systems either individually or as a combination of cupolets to model such speech and music signals. The term “cupolet” will be used hereinafter exclusively, and is meant to also include bit strings and/or waveforms is systems other than chaotic systems are used for data compression and transmission.

During the selection process, a vector of significant frequencies may be determined for each component and is then compared to cupolets, through an inner product algorithm. The cupolet with the best psychoacoustic fit may be chosen and adjusted in phase and amplitude to match the original signal. A residual may also be computed and utilized (e.g., included in a compressed data signal). The process may continue in an iterative manner until all of the signal components are represented.

Step 235 is a prioritization step that may, for example, utilize the decomposed data signal and the UPM to sort classes of objects (e.g., noise-like components and oscillatory components) in order of perceptual relevance. The ability to prioritize allows for a signal to be segregated into layers. To transmit at a particular bitrate, the most important layers that can be transmitted at that bitrate are transmitted. Thus, the output of prioritization step 235 can be stored (e.g., in intermediate file 240) and utilized for transmission at any bitrate. It should be noted that the intermediate file 240 includes all layers, from the layers that can be transmitted at the lowest bitrate to the layers requiring the highest available bitrate. The ability to prioritize therefore allows for the realization of a real-time dynamic bitrate delivery system. More particularly, the stored prioritized (e.g., layered) signal may be transmitted over a channel that has time-varying bandwidth. As such, the bandwidth of the channel may be determined periodically and the signal may be transmitted at that bandwidth for that period. Such an application may be useful, for example, in long-range audio communications (e.g., audio communications out of the Earth's atmosphere), or over networks where network contention can produce variability in the available bandwidth.

As mentioned above, the output of prioritization step 235 may be written into an intermediate file 240 (e.g., a floating-point file format such as .CCA or .CCM). Persons skilled in the art will appreciate that the output of any step of the process of flow chart 200 may be saved into memory or as a file in a particular file format.

Step 245 quantizes the parameters of each signal component. Such a quantization can be based on a sensitivity measure derived from the UPM. As such, the UPM may be utilized for quantization purposes as well as the output of prioritization step 235. For systems without a prioritization step (e.g., for systems without a scalability feature), quantization step can utilize the decomposed signal objects from step 225. In step 245, quantized values are distributed to maximize the efficiency of the compression algorithm applied in step 250.

Step 250 compresses the data. Step 250 is preferably a lossless compression scheme, as disclosed, for example, in U.S. patent application Ser. No. 10/106,696, filed 22 Mar. 2002, the contents of which is incorporated herein by reference in its entirety. However, any compression scheme may be applied at step 250. Regardless, elements can be arranged in layers, with the perceptually (psychoacoustically) most relevant elements assigned to lower layers. However, it should be noted that all layers reside in a single file, which allows for scalability after compression. As such, compression, or pre-processing, of the data is independent of the bitrate utilized by or available to a particular device (e.g., a mobile device). The least significant layers that would require a bitrate greater than the available transmission bitrate are removed. If more bandwidth becomes available, omitted layers can be added to the transmitted signal (e.g., to the bitstream) according to their psychoacoustic priority.

Persons skilled in the art will appreciate that the ability to prioritize, segregate, and scale can dictate the level of quality of a signal. Such a functionality can be utilized in a number of advantageous applications. For example, fewer layers may be provided when a user previews music. Thus, if the previewed music is illegally copied and distributed, the illegal copy of the music is inferior to the copy that can be obtained through legal distribution (i.e., through the distribution of a signal with a larger number of layers).

After the data is compressed, the output of step 250 (e.g., the compressed layers) can be stored in an output file (e.g., a .KOZ file) in step 255. The file, or a selected portion of the file, may then be transmitted over a communications channel (e.g., wirelessly or over a wire)

On the decoding side, the quantized parameters are extracted from the received file (e.g., a .KOZ file) such that each object can be reconstructed. The objects represent information in the Unified Domain and, as such, have a direct translation into either the frequency or time domains. Such attributes allow for a number of different encoder configurations to be utilized. Additionally, as a result of the components being reconstructed independently from one another, the ability to alter the computational load associated with each component is provided. Similarly, the ability to perform, or utilize, the components as the components become available is provided. After each component is resynthesized in either the time or frequency domain, the individual components can be added together and the resultant frame of audio can be written to an output audio buffer for playback.

Persons skilled in the art will appreciate that the processors for a number of mobile devices (e.g., cellular telephones) employ fixed-point math operations. Rounding errors can accumulate in such processors and can introduce audible artifacts in the audio. Accordingly, signal coefficients can be adaptively scaled in the decoder in order to maintain a high signal-to-noise ratio while minimizing rounding error noise throughout the decoding process.

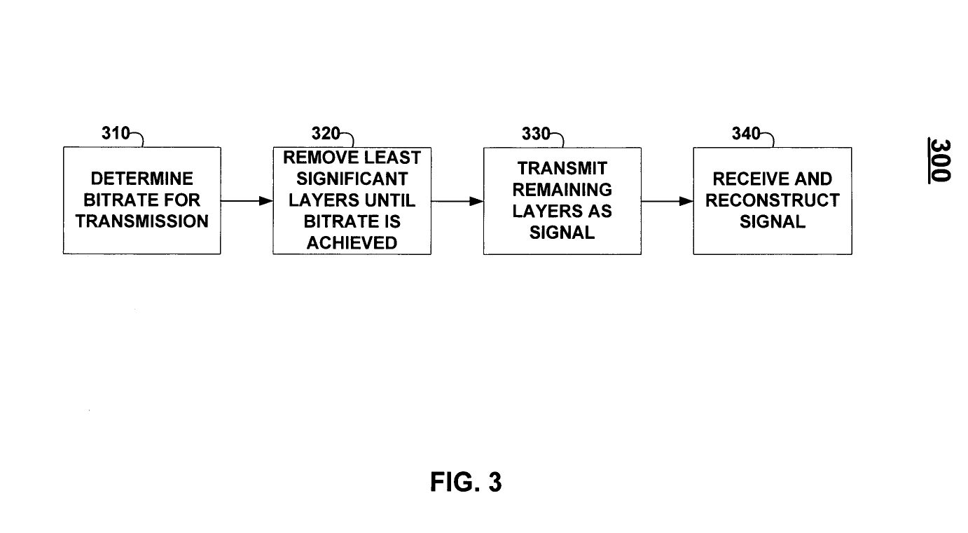

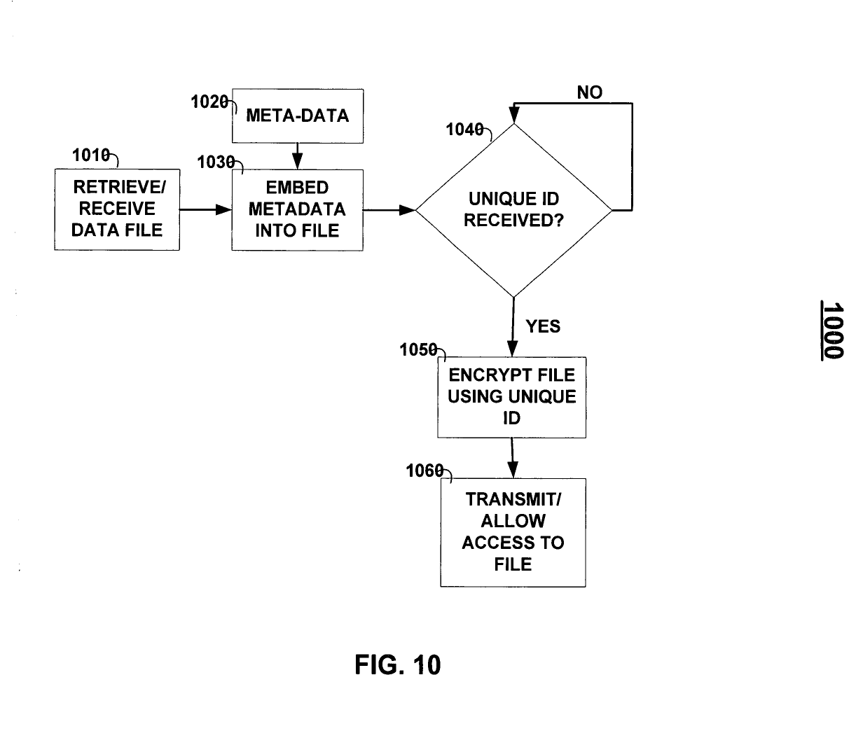

FIG. 3 shows an exemplary process 300 for scaling data. Here, the bitrate for transmission is determined in step 310. Next, if necessary, the least significant (e.g., least psychoacoustically important) layers are removed until the desired bitrate is achieved in step 320. Next the remaining layers are transmitted in step 330. The signal is then received and reconstructed at step 340. Details of the reconstruction may be subject to prior authorization to select certain layers or subsets of layers for signal reconstruction, for example, through a password or digital rights management (DRM), which will be described later with reference to FIG. 10.

Turning next to FIG. 4, one embodiment of the transformation of a multiple channel signal into the Unified Domain is provided as the process of flow chart 400. Generally, the multiple channel data is retrieved (e.g., retrieved from memory) or received (e.g., received from a content provider) in step 410. A window (e.g., a frame) of the retrieved/received data is then selected for transformation in step 420. The signal is transformed to the frequency domain in step 430. Next, the signal in the frequency domain is multiplied by the Special Unitary group vector of matrices, which will be described in detail below. The result of the multiplication is then stored, or transmitted, with the complex matrix in step 450. Steps 490 and 495 may be included to, for example, create an iterative process until all the data has been transformed. Particularly, step 490 may determine if the data has been exhausted. If data is still available to be transformed, then step 490 continues to step 420. Else, step 490 continues to step 495. Here, the data may be utilized in step 495 or the next processing step in a larger process may be activated. Persons skilled in the art will appreciate that instead of processing data as a whole, the data may be processed in windows (e.g., frames). As a result, step 450 may activate the next processing step in a larger process after the transformed window of data is obtained or stored.

The transformation provides a way to analyze data simultaneously in multiple channels, such as might be present in music for stereo music with two channels or surround sound music with multiple channels. Similarly, one can consider image and video data to be composed of multiple channels of data, such as in the RGB format with Red, Blue, and Green channels. The end result is that the multi-channel signal is represented in the form of a one-dimensional magnitude vector in the frequency domain, multiplied by a vector of matrices taken from the Special Unitary Group, SU(n). Accordingly, a more particular transformation of a multiple channel signal to a signal in the Unified Domain can occurs as follows.

In one illustrative example, the input data is stereo music containing two channels of data designated Left and Right, and the result is a magnitude vector multiplied by a vector of matrices from the Special Unitary Group of dimension 2, SU(2) . This transformation proceeds in several steps. The first step is to select a window of music data and transform it to the frequency domain using a transformation such as the Discrete Fourier Transform (DFT). The result is a representation of the signal in discrete frequency bins, and if N samples were selected in the window of data, there will be, in general, N frequency bins, although there are variations of these transforms known to those skilled in the art that would alter the number of frequency bins.

Once in the frequency domain, two channels of (generally) complex frequency information are available, so each frequency bin can be viewed as a complex vector with two elements. These are then multiplied by a complex matrix taken from the group SU(2), resulting in a single magnitude component. This magnitude component is then stored with the matrix as the representation of the stereo music.

Such steps can be represented mathematically as follows:
left channel: \vec{S}L=s_{0L}, s_{1L}L, s_{2L}, . . .
right channel: \vec{S}R=s_{0R}, S_{1R}, s_{2R}, . . .

To convert to the frequency domain, the following mathematical operations can be performed:
\vec{F}_{L}=DFT(\vec{s}_{L})
\vec{F}_{R}=DFT(\vec{s}_{R})

The group elements can be represented in a number of ways. For the SU(2) matrices for two channels of data the representation can take the form given by:

$$U = [ \begin{matrix}{ⅇ}^{- {ⅈϕ}_{1}} cos σ & {ⅇ}^{- {ⅈϕ}_{2}} sin σ \\ - {ⅇ}^{{ⅈϕ}_{2}} sin σ & - {ⅇ}^{{ⅈϕ}_{1}} cos σ\end{matrix} ]$$

The angles with components of the frequency domain vectors can then be identified as follows. Let the j^{th} complex component of \vec{F}_{L} be designated as aⱼ+ibⱼ=r_{Lj}e^{iφ}^{₁} and the j^{th} complex component of \vec{F}_{R} be designated as cⱼ+idⱼ=r_{Rj}e^{iφ}^{₂}. The complex frequency components can then be identified with the elements of the SU(2) matrix for the j^{th} frequency bin because cos σ=r_{Lj}/\sqrt{r_{Lj}²+r_{Rj}²} and sin σ=r_{Rj}/\sqrt{r_{Lj}²+r_{Rj}²}, and the phase variables are the same φ₁ and φ₂ values. If the SU(2) matrix is multiplied by a 2-vector of the frequency components for the j^{th} frequency bin, then the result is a single magnitude vector:

$$[ {U}_{j} ] [ \begin{matrix}{F}_{Lj} \\ {F}_{Rj}\end{matrix} ] = [ \begin{matrix}\sqrt{{r}_{Lj}^{2} + {r}_{Rj}^{2}} \\ 0\end{matrix} ]$$

and, since the SU(2) matrices are preferably unitary and have inverse matrices, all of the information can be contained in the magnitude vector and the U matrix. Thus, a new representation for the two channel data can be provided that contains all of the information that was present in the original:

$$\sqrt{{r}_{Lj}^{2} + {r}_{Rj}^{2} } [ {U}_{j} ] = \sqrt{{r}_{Lj}^{2} + {r}_{Rj}^{2}} [ \begin{matrix}{ⅇ}^{- {ⅈϕ}_{1}} cos {σ}_{j} & {ⅇ}^{- {ⅈϕ}_{2}} sin {σ}_{j} \\ - {ⅇ}^{{ⅈϕ}_{2}} sin {σ}_{j} & - {ⅇ}^{{ⅈϕ}_{1}} cos {σ}_{j}\end{matrix} ] .$$

Once the data is represented in the Unified Domain representation, what had previously been considered to be two independent channels of music, represented as right and left frequencies, can now be represented in the Unified Domain as a single magnitude vector multiplied by a complex matrix from SU(2). The transformation can be inverted easily, so it is possible to change back and forth in a convenient manner.

Most multi-channel signals can be processed in the Unified Domain. One suitable signal analysis technique already mentioned above is the Complex Spectral Phase Evolution (CSPE) method which can analyze and detect the presence of short-term stable sinusoidal components in, for example, an audio signal. The method provides for an ultra-fine resolution of frequencies by examining the evolution of the phase of the complex signal spectrum over time-shifted windows. This analysis, when applied to a sinusoidal signal component, allows for the resolution of the true signal frequency with orders of magnitude greater accuracy than with a Discrete Fourier Transform (DFT). Further, this frequency estimate is independent of the actual frequency (frequency bin) and can be estimated from “leakage” bins far from spectral peaks. The method is robust in the presence of noise or nearby signal components, and is a fundamental tool in the front-end processing for the KOZ compression technology used, for example, with chaotic systems.

The application of CSPE in the Unified Domain, hereinafter referred to as Unified CSPE, includes converting a window of data referred to as window Λ₁ to the Unified Domain, and then converting a time-shifted window Λ₂ of data to the Unified Domain. The Unified CSPE then calls for the calculation of Λ₁⊙Λ₂*, where the operator ⊙ means to take the component-wise product of the matrices over all of the frequency bins, and the asterisk (*) indicates that the complex conjugate is taken. To get the remapped frequencies of the CSPE in the Unified Domain, the arguments of the complex entries in the Unified CSPE are calculated.

Similarly, additional signal processing functions can be advantageously reformulated so that these additional functions can be computed in the Unified Domain. There is a mathematical equivalence between the Unified Domain and the usual representations of data in the frequency domain or the time domain.

Turning next to FIG. 5, process flow chart 500 depicts an exemplary CSPE high-resolution frequency signal analysis. Generally, N samples are obtained from the signal in the unified domain in step 501. A transformation into the frequency domain, such as a Discrete Fourier Transform (DFT) or Fast Fourier Transform (FFT) is performed on the samples in step 502. Similarly, N samples are obtained from the time-delayed signal in the unified domain in step 503 and a Fourier transform is applied to these time delayed samples in step 504. The phase evolution between the samples from steps 501 and 502 and steps 503 and 504 are analyzed in step 510. Particularly, the conjugate product of the transforms is obtained in step 511 and then the angle of this conjugate product is obtained in step 512. Using this product and angle information, numerous advantageous applications may be realized. For example, the angle can be compared to the transforms from steps 502 and 504 to determine fractional multiples in step 520 such that the correct underlying (dominant) frequency or frequencies of the signal can be determined in step 525. Accordingly, the power in the frequency bins of the Fourier transforms can be re-assigned in step 520 to, among other things, correct the frequency by reassigning the signal power in a frequency bin to the source signal frequency that produced the signal power.

The CSPE algorithm allows for the detection of oscillatory components in the frequency spectrum of a signal and generally gives improved resolution to the frequencies over that which is inherent in a transform. As stated above, the calculations can be done with the DFTs or the FFTs. Other transforms, however, can be used including continuous transforms.

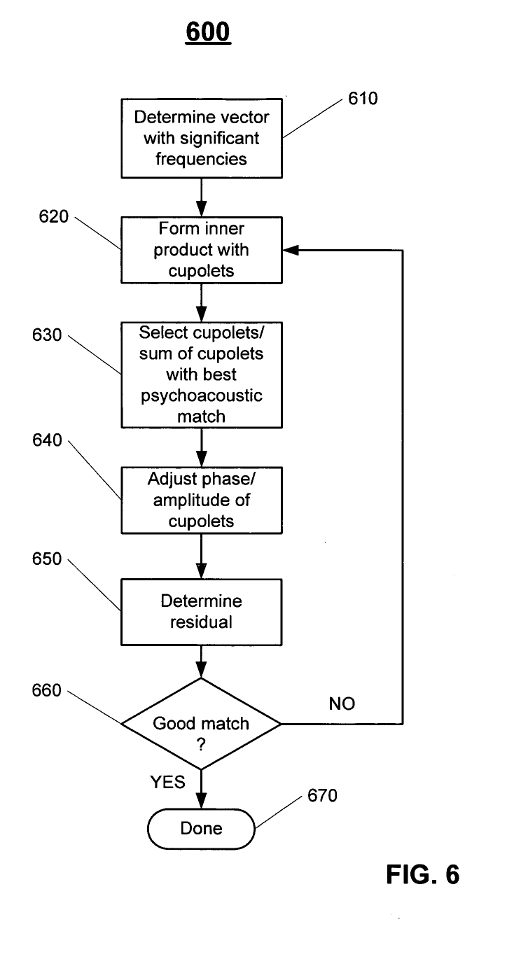

Once the separate signal components are isolated, the signal is synthesized in an additive approach. This synthesis is shown in the schematic flow diagram 600 of FIG. 6. The dominant part of the process 600 is the step of selecting the cupolets that are the best match to the signal elements. First, at step 610, a set of cupolets with the correct spectral characteristic for a given component is selected by determining a vector of significant frequencies for each component. At step 620, the vector is then compared to the cupolets through a modified inner product, and the cupolet with the best psychoacoustic fit is selected, at step 630. The amplitude and phase of the cupolet are then adjusted to match the original signal, at step 640. At step 650, a residual is computed and it is checked, at step 660, if the residual is small enough so as to obtain a good match between the signal and the cupolets. If the match is satisfactory, process 600 ends at step 670. Otherwise, the process 600 returns to step 620 and continues in an iterative fashion until all signal components are represented. Those skilled in the art will appreciate that a combination of cupolets, such as a linear combination which may be weighted, can be used for the comparison.

As shown in one example, suppose a signal, s(t), is given and a sampled version of the same signal, \vec{s}=(s₀,s₁,s₂,s₃, . . . ) is defined. If N samples of the signal are taken, the DFT of the signal can be calculated by first defining the DFT matrix. In allowing W=e^{i2π/N} the matrix can be written as:

$$W = [ \begin{matrix}1 & 1 & 1 & 1 & ⋯ & 1 \\ 1 & W & {W}^{2} & {W}^{3} & ⋯ & {W}^{N - 1} \\ 1 & {W}^{2} & {W}^{4} & {W}^{6} & ⋯ & {W}^{2 ( N - 1 )} \\ 1 & {W}^{3} & {W}^{6} & {W}^{9} & ⋯ & {W}^{3 ( N - 1 )} \\ ⋮ & ⋮ & ⋮ & ⋮ & ⋰ & ⋮ \\ 1 & {W}^{N - 1} & {W}^{2 ( N - 1 )} & {W}^{3 ( N - 1 )} & ⋯ & {W}^{( N - 1 ) ( N - 1 )}\end{matrix} ]$$

where each column of the matrix is a complex sinusoid oscillating an integer number of periods over the N point sample window.

Persons skilled in the art will appreciate in the definition of W, the sign in the exponential can be changed, and in the definition of the CSPE, the complex conjugate can be placed on either the first or second term.

For a given block of N samples, define:

$${{S}^{->}}_{0} = [ \begin{matrix}{s}_{0} \\ {s}_{1} \\ {s}_{2} \\ {s}_{3} \\ ⋮ \\ {s}_{N - 1}\end{matrix} ] , {{S}_{1}}^{->} = [ \begin{matrix}{s}_{1} \\ {s}_{2} \\ {s}_{3} \\ {s}_{4} \\ ⋮ \\ {s}_{N}\end{matrix} ] , and in general , {{s}^{->}}_{i} = [ \begin{matrix}{s}_{i} \\ {s}_{i + 1} \\ {s}_{i + 2} \\ {s}_{i + 3} \\ ⋮ \\ {s}_{i + N - 1}\end{matrix} ] ,$$

the DFT of the signal may then be:

$$F ( {{s}^{->}}_{i} ) = [ \begin{matrix}1 & 1 & 1 & 1 & ⋯ & 1 \\ 1 & W & {W}^{2} & {W}^{3} & ⋯ & {W}^{N - 1} \\ 1 & {W}^{2} & {W}^{4} & {W}^{6} & ⋯ & {W}^{2 ( N - 1 )} \\ 1 & {W}^{3} & {W}^{6} & {W}^{9} & ⋯ & {W}^{3 ( N - 1 )} \\ ⋮ & ⋮ & ⋮ & ⋮ & ⋰ & ⋮ \\ 1 & {W}^{N - 1} & {W}^{2 ( N - 1 )} & {W}^{3 ( N - 1 )} & ⋯ & {W}^{( N - 1 ) ( N - 1 )}\end{matrix} ] [ \begin{matrix}{s}_{i} \\ {s}_{i + 1} \\ {s}_{i + 2} \\ {s}_{i + 3} \\ ⋮ \\ {s}_{i + N - 1}\end{matrix} ]$$

As described above, the CSPE may analyze the phase evolution of the components of the signal between an initial sample of N points and a time-delayed sample of N points. Allowing the time delay be designated by Δ, the CSPE may be defined as the angle of the product of F(\vec{s}ᵢ) and the complex conjugate of F(\vec{s}_{i+Δ}) or CPS=≮(F(\vec{s}ᵢ)F*(\vec{s}_{i+Δ})) (which may be taken on a bin by bin basis and may be equivalent to the “.*” operator in Matlab™), where the operator ≮ indicates that the angle of the complex entry resulting from the product is taken.

To illustrate this exemplary process on sinusoidal data, take a signal of the form of a complex sinusoid that has period p=q+δ, where q is an integer and δ is a fractional deviation of magnitude less than 1, i.e., |δ|≦1. The samples of the complex sinusoid can be written as follows (the phase may be arbitrary and, as such, may be set to zero for simplicity):

$${{s}^{->}}_{0} = [ \begin{matrix}{ⅇ}^{0} \\ {ⅇ}^{ⅈ2π \cdot \frac{q + \partial }{N}} \\ {ⅇ}^{ⅈ2π \cdot 2 \frac{q + \partial }{N}} \\ {ⅇ}^{ⅈ2π \cdot 3 \frac{q + \partial }{N}} \\ ⋮ \\ {ⅇ}^{ⅈ2π \cdot ( N - 1 ) \frac{q + \partial }{N}}\end{matrix} ]$$

If one were to take a shift of one sample, then Δ=1 in the CSPE, and:

$${{s}^{->}}_{1} = [ \begin{matrix}{ⅇ}^{ⅈ2π \cdot \frac{q + \partial }{N}} \\ {ⅇ}^{ⅈ2π \cdot 2 \frac{q + \partial }{N}} \\ {ⅇ}^{ⅈ2π \cdot 3 \frac{q + \partial }{N}} \\ {ⅇ}^{ⅈ2π \cdot 4 \frac{q + \partial }{N}} \\ ⋮ \\ {ⅇ}^{ⅈ2π \cdot N \frac{q + \partial }{N}}\end{matrix} ]$$

which can be rewritten to obtain:

$${{s}^{->}}_{1} = [ \begin{matrix}{ⅇ}^{ⅈ2π \cdot \frac{q + \partial }{N}} \\ {ⅇ}^{ⅈ2π \cdot 2 \frac{q + \partial }{N}} \\ {ⅇ}^{ⅈ2π \cdot 3 \frac{q + \partial }{N}} \\ {ⅇ}^{ⅈ2π \cdot 4 \frac{q + \partial }{N}} \\ ⋮ \\ {ⅇ}^{ⅈ2π \cdot N \frac{q + \partial }{N}}\end{matrix} ] = {ⅇ}^{ⅈ2π \cdot \frac{q + \partial }{N}} [ \begin{matrix}{ⅇ}^{0} \\ {ⅇ}^{ⅈ2π \cdot \frac{q + \partial }{N}} \\ {ⅇ}^{ⅈ2π \cdot 2 \frac{q + \partial }{N}} \\ {ⅇ}^{ⅈ2π \cdot 3 \frac{q + \partial }{N}} \\ ⋮ \\ {ⅇ}^{ⅈ2π \cdot ( N - 1 ) \frac{q + \partial }{N}}\end{matrix} ] = {ⅇ}^{ⅈ2π \cdot \frac{q + \partial }{N}} {{s}^{->}}_{0}$$

Inserting the above into the conjugate product of the transforms, the result is:
F(\vec{s}ᵢ)F*(\vec{s}ᵢ₊ₐ)=e^{-i2π·q+δ/N}F(\vec{s}ᵢ)F*(\vec{s}ᵢ)=e^{-i2π·q+δ/N}∥F(\vec{s}ᵢ)∥²
The CSPE is found by taking the angle of this product to find that:

$$\frac{2 π}{N} CSPE ( {\vec{s}}_{i} , {\vec{s}}_{i + 1} ) = ∢ ( F ( {\vec{s}}_{i} ) {F}^{*} ( {\vec{s}}_{i + 1} ) ) = 2 π \cdot \frac{q + δ}{N}$$

Comparing the above equation to the information in the standard DFT calculation, the frequency bins are in integer multiples of

$$\frac{2 π}{N} ,$$

and so the CSPE calculation provided information that determines that instead of the signal appearing at integer multiples of

$$\frac{2 π}{N} ,$$

the signal is actually at a fractional multiple given by q+δ. This result is independent of the frequency bin under consideration, so the CSPE allows one to, for example, determine the correct underlying or dominant frequency or frequencies, no matter what bin in the frequency domain is considered. In looking at the DFT of the same signal, the signal can have maximum power in frequency bin q−1, q, or q+1, and, if δ≠0, the signal power may leak to frequency bins well outside this range of bins. The CSPE, on the other hand, allows the power in the frequency bins of the DFT to be re-assigned to the correct underlying or dominant frequencies that produced the signal power—anywhere in the frequency spectrum.

Persons skilled in the art will appreciate that in the definition of the W matrix, the columns on the right are often interpreted as “negative frequency” complex sinusoids, since

$$[ \begin{matrix}1 \\ {W}^{N - 1} \\ {W}^{2 ( N - 1 )} \\ {W}^{3 ( N - 1 )} \\ ⋮ \\ {W}^{( N - 1 ) ( N - 1 )}\end{matrix} ] = [ \begin{matrix}1 \\ {W}^{- 1} \\ {W}^{- 2} \\ {W}^{- 3} \\ ⋮ \\ {W}^{1}\end{matrix} ]$$

similarly the second-to-last column is equivalent to:

$$[ \begin{matrix}1 \\ {W}^{- 2} \\ {W}^{- 4} \\ {W}^{- 6} \\ ⋮ \\ {W}^{2}\end{matrix} ]$$

Turning next to FIG. 7, a process 700 referred to as Unified Psychoacoustic Model (UPM) applies a Psychoacoustic Model to the unified CSPE data determined by process 500 of FIG. 5. At step 710, the unified CSPE data is retrieved (or received). The spatial position and internal phase relationship of signal components is then determined in step 720. From this data, the masking surface over the entire spatial field of data can be obtained in step 730. Similarly, at step 740, a frequency mask with spatial component can be obtained by multiplying the mask with the spatial component. Similarly still, the masking surface for every signal component can be derived in step 750.

The Unified Domain Representation can advantageously be employed to perform psychoacoustic analysis of the multi-channel input. For instance, in compression of music files, it is important to be able to determine the relative importance of signal components, and in many codecs, frequency components that have little psychoacoustic significance are deleted or quantized dramatically. The process of converting to the Unified Domain, calculation of high-resolution Unified CSPE information, and calculation of psychoacoustic masking surfaces in the Unified Domain, provides the possibility to jointly consider all of the components that make up a multi-channel signal and process them in a consistent manner. When coupled with the remapping of the frequencies in the Unified CSPE, it becomes possible to consider the signal components as having a spatial position and internal phase relationships. This is done, for example, in the case where the input data is stereo music with right and left channels, by associating the spatial effect of the stereo music to operate over a field spanning an angle of 90°. In this view, a signal component that occurs with a given value of σ can be viewed as occurring at angle σ in the stereo field, with a magnitude given by the magnitude component derived from the Unified Domain representation magnitude values. Furthermore, the internal phase angles of the two channels are preserved in the φ₁ and φ₂ values assigned to that signal component.

Considering the case where the music/audio on the left and right channels is composed of two components, with frequencies f₀ and f₁, then when converted to the Unified Domain and processed with the Unified CSPE, these signals can be associated with their magnitudes, spatial positions, and internal phases so f₀←→|f₀|, σ₀, φ₀₁ and φ₀₂ and for the second signal, the association is f₁←→|f₁|, σ₁, φ₁₁ and φ₁₂.

Equations for frequency masking can be adapted to have a spatial component, so that if a signal component such as f₀ would have a one-dimensional masking effect over nearby frequencies that is given by the masking function G(f₀; f), then if one were to extend this masking effect to the unified domain, the unified masking function can pick up a spatial component related to the angular separation between the signal components, and this masking can be represented as a masking surface H(f₀;f,σ)=G(f₀;f)·cos(σ−σ₀), where the cosine function represents the spatial component. Similarly, a masking surface can be derived for every signal component and a global masking surface defined over the entire spatial field of the data can be found, for example, by taking the sum of the masking functions at a given point in the spatial field, or the maximum of the maskers at a given point in the spatial field or the average of the masking functions at a point in the spatial field or any of a number of other selection rules for the masking functions at a point in the spatial field. Further, other spatial functions than the cosine function can be utilized as well as functions that drop off faster in the spatial direction or functions that fall off slower in the spatial direction.

The CSPE technique can also be utilized for real signals in addition to complex signals, as real functions can be expressed as the sum of a complex number and its conjugate number. Consider a real sinusoid with period p=q+δ where p is an integer and δ is a fractional deviation of magnitude less than 1, i.e. |δ|≦1, with amplitude “a” and arbitrary phase. The samples of a real sinusoid can be written as linear combinations of complex sinusoids, such as the following:

$${\vec{s}}_{0 ( n )} = \frac{a}{2} {ⅇ}^{j \frac{2 π ( q + δ )}{N} n} + \frac{a}{2} {ⅇ}^{- j \frac{2 π ( q + δ )}{N} n}$$

and the one sample shift would be:

$${\vec{s}}_{1 ( n )} = \frac{a}{2} {ⅇ}^{j \frac{2 π ( q + δ )}{N} n} {ⅇ}^{j \frac{2 π ( q + δ )}{N}} + \frac{a}{2} {ⅇ}^{- j \frac{2 π ( q + δ )}{N} n} {ⅇ}^{- j \frac{2 π ( q + δ )}{N}}$$

if

$$D = {ⅇ}^{j \frac{2 π ( q + δ )}{N}}$$

is defined, the vectors may be written as:

$${\vec{s}}_{0 ( n )} = \frac{a}{2} {D}^{n} + \frac{a}{2} {D}^{- n}$$

$${\vec{s}}_{1 ( n )} = \frac{a}{2} {D}^{n} D + \frac{a}{2} {D}^{- n} {D}^{- 1}$$

The DFT of each one of these vectors can then be:

$$F ( {\vec{s}}_{0} ) = F ( \frac{a}{2} {D}^{n} + \frac{a}{2} {D}^{- n} )$$

$$F ( {\vec{s}}_{0} ) = \frac{a}{2} F ( {D}^{n} ) + \frac{a}{2} F ( {D}^{- n} )$$

$$F ( {\vec{s}}_{1} ) = F ( \frac{a}{2} {D}^{n} D + \frac{a}{2} {D}^{- n} {D}^{- 1} )$$

$$F ( {\vec{s}}_{1} ) = \frac{a}{2} DF ( {D}^{n} ) + \frac{a}{2} {D}^{- 1} F ( {D}^{- n} )$$

The CSPE may be computed using the complex product F(\vec{s}₀)⊙F*(\vec{s}₁) of the shifted and unshifted transforms, where the product operator ⊙ can be defined as the complex product taken element-by-element in the vector:

$$\begin{matrix}F ( {{s}^{->}}_{0} ) {F}^{*} ( {{s}^{->}}_{1} ) = [ \frac{a}{2} F ( {D}^{n} ) + \frac{a}{2} F ( {D}^{- n} ) ] ⊙ \\ {[ \frac{a}{2} DF ( {D}^{n} ) + \frac{a}{2} {D}^{- 1} F ( {D}^{- n} ) ]}^{*} \\ = {( \frac{a}{2} )}^{2} [ F ( {D}^{n} ) + F ( {D}^{- n} ) ] ⊙ [ {D}^{*} {F}^{*} ( {D}^{n} ) + {DF}^{*} ( {D}^{- n} ) ]\end{matrix}$$

By expanding the product, the following can be obtained.

$$F ( {{s}^{->}}_{0} ) {F}^{*} ( {{s}^{->}}_{1} ) = {( \frac{a}{2} )}^{2} [ \begin{matrix}{D}^{*} F ( {D}^{n} ) ⊙ {F}^{*} ( {D}^{n} ) + \\ DF ( {D}^{n} ) ⊙ {F}^{*} ( {D}^{- n} ) + \\ {D}^{*} F ( {D}^{- n} ) ⊙ {F}^{*} ( {D}^{n} ) + \\ DF ( {D}^{- n} ) ⊙ {F}^{*} ( {D}^{- n} )\end{matrix} ]$$

Simplifying the above equation can produce:

$$F ( {{s}^{->}}_{0} ) {F}^{*} ( {{s}^{->}}_{1} ) = {( \frac{a}{2} )}^{2} [ \begin{matrix}{D}^{*} {‖ F ( {D}^{n} ) ‖}^{2} + \\ DF ( {D}^{n} ) ⊙ {F}^{*} ( {D}^{- n} ) + \\ {D}^{*} F ( {D}^{- n} ) ⊙ {F}^{*} ( {D}^{n} ) + \\ D {‖ F ( {D}^{- n} ) ‖}^{2}\end{matrix} ]$$

The above simplified equation can be viewed, for example, as a sum of the CSPE for a “forward-spinning” or “positive-frequency” complex sinusoid and a “backward-spinning” or “negative-frequency” complex sinusoid, plus interaction terms. The first and the last terms in the sum can be the same as previously discussed CSPE calculations, but instead of a single complex sinusoid, there can be a linear combination of two complex sinusoids—so the contributions to the CSPE from these two terms represent highly-concentrated peaks positioned at q+δ and −(q+δ), respectively.

The interaction terms can have some properties that can decrease the accuracy of the algorithm if not handled properly. As will be shown below, the bias introduced by the interaction terms can be minimized by windowing the data. Additionally, the interaction terms, Γ, can be simplified as follows:
Γ=[DF(Dⁿ)⊙F*(D⁻ⁿ)+D*F(D⁻ⁿ)⊙F*(Dⁿ)]
Γ=2*Re[DF(Dⁿ)⊙F*(D⁻ⁿ)]

F(Dⁿ) may be, for example, a peak concentrated at frequency position q+δ, and that F(D⁻ⁿ) may be a peak concentrated at frequency position −(q+δ), and that the product may be taken on an element-by-element basis, (Γ≈0 for a number of cases). The data can be analyzed using an analysis window, such as Hanning, Hamming, or rectangular window. The measured spectrum may be found by convolving the true (delta-like) sinusoidal spectrum with the analysis window. So, for example, if a rectangular window (e.g., a the boxcar window) is used, the leakage into nearby spectral bins may be significant and may be of sufficient strength to produce significant interaction terms—which may even cause the ∥●∥² terms to interfere.

To reduce the chance of significant interaction terms, another analysis window known in the art may be utilized so that the leakage is confined to the neighborhood of q+δ and −(q+δ), so the Γ≈0 case is the most common situation.

After the CSPE is calculated, the frequencies can be reassigned by extracting the angle information. For the positive frequencies (k>0), it can be determined that:

$$\begin{matrix}{f}_{CSPE k} = \frac{- N ∡ ( {F}_{k} ( {{s}^{->}}_{0} ) {F}_{k}^{*} ( {{s}^{->}}_{1} ) )}{2 π} \\ = \frac{- N ∡ ( {( \frac{a}{2} )}^{2} {‖ {F}_{k} ( {D}^{n} ) ‖}^{2} {ⅇ}^{- j \frac{2 π ( q + δ )}{N}} )}{2 π} \\ = \frac{- N ( - \frac{2 π ( q + δ )}{N} )}{2 π}\end{matrix}$$

$${f}_{CSPE k} = ( q + δ )$$

and for the negative frequencies (k<0), the opposite value, f_{CSPEk}=−(q+δ) can be determined.

Consequently, in the case of real signals (for Γ≈0), all of the power in the positive frequencies can be remapped to q+δ and all of the power in the negative frequencies can be remapped to −(q+δ). Such a result is substantially independent of the frequency bin and allows for extremely accurate estimates of frequencies.

CSPE can be performed for real sinusoids that have been windowed with an analysis window and can be generalized, for example, to include the effects of windowing by defining the basic transform to be a windowed transform.

Data can be windowed before computing the DFT and, for example, an arbitrary analysis window, A(t), and its sampled version Aₙ can be defined. The transforms may be performed as discussed above—and the analysis window can be pre-multiplied by:
F(\vec{s}₀)→F(\vec{A}⊙\vec{s}₀)≡F_{W}(\vec{s}₀)
where the W subscript indicates a windowed transform is being utilized.

Thus, in the presence of windowing, the following is obtained:

$${F}_{W} ( {{s}^{->}}_{0} ) {F}_{W}^{*} ( {{s}^{->}}_{1} ) = {( \frac{a}{2} )}^{2} [ \begin{matrix}{D}^{*} {‖ {F}_{W} ( {D}^{n} ) ‖}^{2} + \\ 2 Re \{ {DF}_{W} ( {D}^{n} ) ⊙ {F}_{W}^{*} ( {D}^{- n} ) \} + \\ D {‖ {F}_{W} ( {D}^{- n} ) ‖}^{2}\end{matrix} ]$$

The leakage into nearby frequency bins is minimized and the interference terms are effectively negligible in most cases.

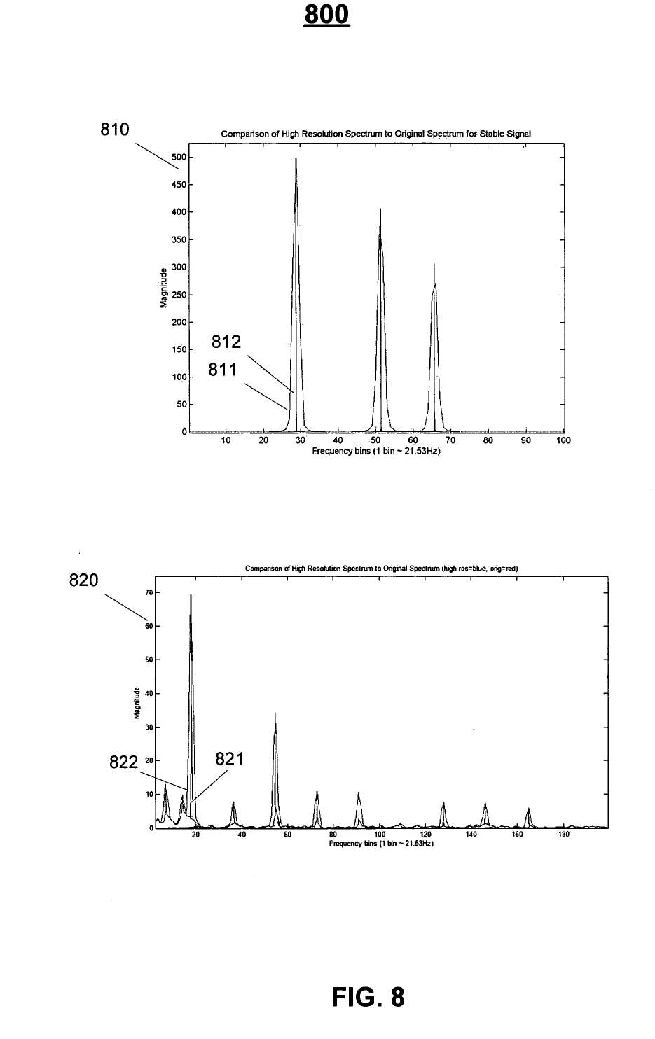

Turning next to FIG. 8, signals 800 are provided and include signal 810 and 820. The original spectra derived from FFT algorithms on the signal sample are shown as the broader peaks 811, while the high-resolution reassigned frequencies using the CSPE method appear as sharp lines at the true underlying or dominant frequencies.

The exemplary signal 811 is composed of three sinusoids. The exemplary signals do-not lie in the center of frequency bins, but the algorithm successfully recalculates the true underlying or dominant frequencies with good accuracy. For this example, the exact frequencies (in frequency bin numbers) are 28.7965317, 51.3764239, and 65.56498312, while the frequencies 812 estimated by the CSPE method are 28.7960955, 51.3771794, and 65.5644420. If these spectra were calculated from music sampled at CD sampling rates of 44100 samples/sec, the resolution of each frequency bin would be approximately 21.53 Hz/bin, so the measured signals are accurate to approximately ±0.001 bins, which is equivalent to ±0.02153 Hz. Regions of the spectrum away from the center of the signal are generally remapped to the nearest dominant signal frequency.

In real-world music the data may not be as clean and stable, and the accuracy of the computed high-resolution spectrum can be affected by the presence of nearby signals that interfere, modulations of the frequencies, and noise-like signals that have a broadband spectrum. Even so, in these situations, the high-resolution analysis generally gives signal accuracy on the order of 0.1 Hz for any signal component that is relatively stable over the sample window. Signal 820 shows a window of data taken from a track by Norah Jones, with line 822 indicating the original data and line 821 indicating the remapped signal. One variation of the algorithm can provide similar resolution for a linearly modulating signal component while returning a high-resolution estimate of the initial signal frequency in the window, along with the modulation rate. This is effected by changing the CSPE to include a multiplication by a complex vector that counteracts the modulation by a measured amount.

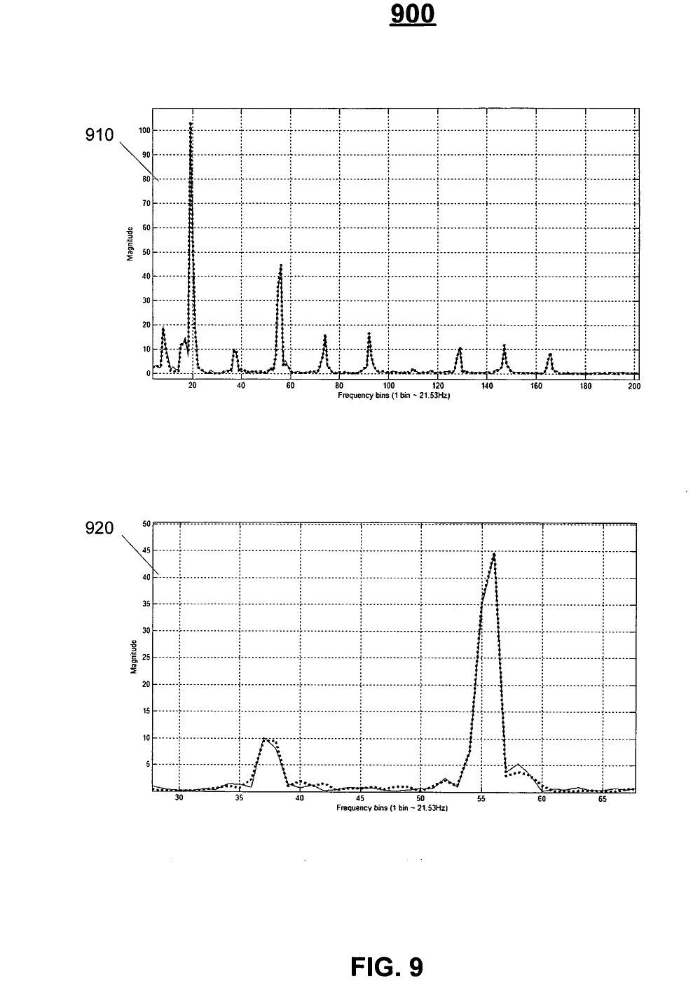

FIG. 9 shows in form of a solid line the signal 820 of FIG. 8 after reconstruction at 32 kbps. The original spectrum is indicated by the dotted line. A zoomed view of curve 910 is shown in FIG. 9 as curve 920, revealing more clearly some of the differences between the original Norah Jones track and the signal reconstructed at 32 kbps. However, the small discernible differences are imperceptible relative to the applied psychoacoustic error bounds. Thus, the disclosed high resolution spectral analysis can be used to reconstruct the discrete transform spectrum of a signal.

The preprocessing processes described above can therefore advantageously be used for data compression and data transmission with a chaotic system. For example, cupolets can be used to synthesize waveforms (e.g., audio data), compress data (e.g., songs or ringtones), remotely generate keys (e.g., encryption/decryption keys), watermark data, and provide secure communications. Cupolets have inherent frequency spectral properties which can be mapped to the unified CSPE frequency analysis, possibly in combination with psychoacoustic filtering.

Once the true frequency of a signal component is estimated, it is possible to make an accurate approximation of the contribution of that signal component to the true measured spectrum of a signal (e.g., as a result of a property of the discrete Fourier Transform when applied to signals that are not centered in the middle of a frequency bin). This process follows from the properties of convolution and windowing.

When a signal is analyzed, for example, a finite number of samples is selected, and a transform is computed. For illustrative purposes, the Discrete Fourier Transform will be utilized, but any transforms (e.g., those with similar properties) may also be used. The transform of the window of data is generally preceded by a windowing step, where a windowing function, W(t), is multiplied by the data, S(t). Suppose W(t) is called the analysis window (and later the windows of data can be reassembled using the same or different synthesis windows). Since the data is multiplied by the window in the time domain, the convolution theorem states that the frequency domain representation of the product of W(t)*S(t) would exhibit the convolution of the transforms, Ŵ(f) and Ŝ(f), where the notation indicates that these are the transforms of W(t) and S(t), respectively. If the high resolution spectral analysis reveals that there is a true signal component of magnitude M₀ at a frequency f₀, then the convolution theorem implies that in the true spectrum one would expect to see a contribution centered at f₀ that is shaped like the analysis window, giving a term essentially of the form M₀Ŵ(f−f₀). In a discrete spectrum, such as the spectrum calculated by the discrete Fourier transform, there is a finite grid of points that result in a sampled version of the true spectrum. Thus, the contribution centered at f₀ described above is sampled on the finite grid points that are integer multiples of the lowest nonzero frequency in the spectrum. Equivalently, if the discrete Fourier transform is calculated for N points of data that has been properly sampled with a sample rate of R samples/sec, then the highest frequency that is captured is the Nyquist frequency of R/2 Hz and there will be N/2 independent frequency bins. This then gives a lowest sampled frequency of (R/2 Hz)/(N/2 bins)=R/N Hz/bin, and all other frequencies in the discrete Fourier transform are integer multiples of R/N.

Because of the relationship between the analysis window transform, Ŵ(f), and the spectral values that have been sampled onto the frequency grid of the discrete transform, such as the discrete Fourier transform, knowledge of Ŵ(f) can be utilized, along with the measured sample values on the grid points nearest to f₀, to calculate a good estimate of the true magnitude, M₀. To calculate this value, the nearest frequency grid point to f₀, called f_{grid} can be found. Then the difference Δf=f₀−f_{grid}, for example, can be obtained and one can read the magnitude value M_{grid} of the transform of the signal at that grid point f_{grid}. The true magnitude can then be calculated from the following relation

$$\frac{{M}_{grid}}{‖ \hat{W} ( - Δ f ) ‖} = \frac{{M}_{0}}{‖ {\hat{W}}_{max} ‖}$$

where ∥Ŵₘₐₓ∥ is taken to mean the maximum magnitude of the transform of the analysis window, which is generally normalized to 1. Also, the transform of the analysis window is generally symmetric, so the sign of Δf may not matter. Persons skilled in the art will appreciate that the above relations can be used with any windowing function.

Assuming, for example, that Ŵ(f) is known with a fixed resolution, then Ŵ(f) can be sampled on a fine-scaled grid that is 2 times, 4 times, 8 times, 16 times, 32 times, or 64 times, or N times finer than the resolution of the frequency grid, or bin size, in the DFT. In this case, the difference value Δf is calculated to the nearest fraction of a frequency bin that corresponds to the fine-scaled grid. So, for example, if the fine scaled grid is 16 times finer than the original frequency grid of the transform, then Δf is calculated to 1/16 of the original frequency grid. The desired fine-grained resolution is dependent on the particular application and can be chosen by one skilled in the art.

Once the estimate of the true signal frequency and magnitude are known, the phase of the true signal can be adjusted so that the signal will align with the phases that are exhibited by the discrete frequency spectrum. So, if φ_{grid} represents the phase angle associated with the magnitude M_{grid}, and φ_{win} represents the phase angle of Ŵ(−Δf), then the analysis window must be rotated by an amount equal to φᵣₒₜ=φ_{grid}−φ_{win}. Once this is done, all of the information about the signal component is captured by the values of f₀, M₀, and φᵣₒₜ.

When reconstructing the signal component, all that is necessary is to take a representation of the analysis window, Ŵ(f), shift it to frequency f₀, rotate it by angle φᵣₒₜ, and multiply it by magnitude M₀ (assuming the analysis window has maximum magnitude equal to 1, otherwise multiply by a factor that scales the window to magnitude M₀).

Returning now to FIGS. 8 and 9, the correct frequency values determined by the disclosed CSPE method were used in the music track represented by signal 820 to determine the correct amplitude values at the correct frequencies and the correct angular rotations, as described above. Curve 910 was reassembled with the correct set of these values.

In signal processing applications, if data is sampled too slowly, then an aliasing problem at high frequencies may be present. Interference also exists at extremely low frequencies and will be referred to herein as the interference through DC problem. This problem occurs when finite sample windows are used to analyze signals. The windowing function used in the sampling is intimately involved, but the problem can occur in the presence of any realizable finite-time window function.

To state the problem more clearly, assume that a signal of frequency f₀ is present and is close to the DC or 0 Hz frequency state. If such a signal is sampled over a finite-time window W(t), then the frequency spectrum of the signal is equal to the convolution in the frequency domain of a delta function at frequency f₀, with the Fourier transform of the windowing function, which is designated as Ŵ(f). In a discrete formulation, the result is then projected onto the grid of frequencies in the discrete transform, e.g., onto the frequency grid of the Fast Fourier Transform (FFT). Since the transform of the windowing function is not infinitely narrow, the spectrum has power spilling over into frequency bins other than the one that contains f₀. In fact, the transform of the windowing function extends through all frequencies, so some of the signal power is distributed throughout the spectrum, and one can think of this as a pollution of nearby frequency bins from the spillover of power. Depending on the windowing function, the rate at which Ŵ(f) falls to zero varies, but for most windows, such as Hanning windows, Hamming windows, Boxcar windows, and Parzen windows, there is significant spillover beyond the bin that contains f₀.

This spillover effect is important throughout the spectrum of a signal, and when two signal components are close in frequency, the interference from the spillover can be significant. However, the problem becomes acute near the DC bin, because any low frequency signal has a complex conjugate pair as its mirror image on the other side of DC. These complex conjugate signals are often considered as “negative frequency” components, but for a low frequency signal, the pairing guarantees a strong interference effect. Luckily, the complex conjugate nature of the pairing allows for a solution of the interference problem to reveal the true underlying or dominant signal and correct for the interference.

To solve this problem, consider the spectrum at f₀, and consider that the measured spectral value at f₀ reflects a contribution from the “positive frequency” component, which will be designated as Ae^{iσ}^{₁}, and a contribution from the mirror image or “negative frequency” component, Be^{iσ}^{₂}. Since the Be^{iσ}^{₂} contribution comes from the negative frequencies at −f₀, the contribution at +f₀ is taken from the conjugate of the analysis window Ŵ*(f). If Ŵ*(f) is assumed to be defined so that it is centered at f=0, then the contribution from the negative frequency component comes from a distance 2f₀ from the center of Ŵ*(f). Consequently, if a high resolution estimate of the frequency f₀, is obtained, then the contributions to the measured spectral value at +f₀ from positive and negative frequencies are known, although the relative phase positions are not yet known and could be determined.

The first step in the process is to set the phase to be 0 at both the +f₀ and −f₀ positions. When set in this position, the values for Ae^{iσ}^{₁} and Be^{iσ}^{₂} are known completely, and so the difference σ₁−σ₂ is obtained. Note that when the phase is 0, the signal components in the +f₀ and −f₀ positions are real, so the complex conjugate spectrum from the negative frequency is in the same relative phase position as the spectrum in the positive frequencies; however, once the phase becomes different from 0, the relative phase values must rotate in the opposite sense, so that if the phase at +f₀ is set to φ, then the phase at −f₀ must be set to −φ to maintain the complex conjugate pairing. This means that in the zero phase orientation, the contributions Ae^{iσ}^{₁} and Be^{iσ}^{₂} have a relative phase difference of σ₁−σ₂, but as the phase orientation at +f₀ is set to φ, the phase orientation at −f₀ counter-rotates and becomes set to −φ, so the contribution Be^{iσ}^{₂} must counter-rotate by the same amount. Thus, in any phase orientation, the net contribution at a given frequency is a combination of rotated and counter-rotated versions of Ae^{iσ}^{₁} and Be^{iσ}^{₂}, and these sums trace out an ellipse. Also, since the major axis of the ellipse will occur when Ae^{iσ}^{₁} and Be^{iσ}^{₂} are rotated into alignment, this occurs when the rotation angle is

$$θ = \frac{1}{2} ( {σ}_{1} - {σ}_{2} )$$

and the sum of the rotated and counter-rotated versions becomes

$${ⅇ}^{\frac{- ⅈ}{2} ( {σ}_{1} - {σ}_{2} )} ( A {ⅇ}^{{ⅈσ}_{1}} ) + {ⅇ}^{\frac{ⅈ}{2} ( {σ}_{1} - {σ}_{2} )} ( B {ⅇ}^{{ⅈσ}_{2}} ) = ( A + B ) {ⅇ}^{\frac{1}{2} ( {σ}_{1} + {σ}_{2} )} ,$$

so the major angle occurs when the rotation and counter-rotation put the terms into alignment at an angle that is the average of the phase angles (there is, of course, a solution for the major axis at an angle that is rotated a further π radians). The position of the minor axis can be similarly determined, since it occurs after a further rotation of π/2 radians. Thus, the sum of the rotated and counter-rotated versions for the minor axis becomes

$${ⅇ}^{i \frac{π}{2}} {ⅇ}^{\frac{- ⅈ}{2} ( {σ}_{1} - {σ}_{2} )} ( A {ⅇ}^{{ⅈσ}_{1}} ) + {ⅇ}^{- ⅈ \frac{π}{2}} {ⅇ}^{\frac{ⅈ}{2} ( {σ}_{1} - {σ}_{2} )} ( B {ⅇ}^{{ⅈσ}_{2}} ) = ( A + B ) {ⅇ}^{\frac{1}{2} ( {σ}_{1} + {σ}_{2} + π )} .$$

The next step in the process is to parameterize the ellipse so that the angular orientation can be determined in a straightforward manner. To start with, consider an ellipse with major axis on the x-axis and of magnitude M, and let S be the magnitude of the minor axis. The ellipse can then be parameterized by τ→(M cos τ, S sin τ), and by specifying a value for τ, any point on the ellipse can be chosen. If τ gives a point on the ellipse, and the angular position, ρ, of the point in polar coordinates (since this will correspond to the phase angle for the interference through DC problem), can be found from the relation

$$tan ρ = \frac{S sin τ}{M cos τ} = \frac{S}{M} tan τ .$$

When this form of parameterization is applied to the interference through DC problem, the ellipse formed by rotated and counter-rotated sums of Ae^{iσ}^{₁} and Be^{iσ}^{₂} is rotated so that the major and minor axes align with the x- and y-axes, and then the measured spectrum is examined to determine the actual angle exhibited by the resultant spectral components.

The resultant phase angle from the measured spectrum is labeled Ω. Since the major axis is at

$$Δ = \frac{1}{2} ( {σ}_{1} + {σ}_{2} ) ,$$

a further rotation is needed to put the resultant at angle Ω, so a τ corresponding to Ω−Δ needs to be determined, and is provided as:

$$tan ( Ω - Δ ) = \frac{A - B}{A + B} tan τ$$

provided as the result:

$$τ = {tan}^{- 1} ( \frac{A + B}{A - B} tan ( Ω - Δ ) )$$

The next step is to recognize that the relations above are determined solely from knowledge of the frequencies and complex conjugate relationship at the +f₀ and −f₀ positions in the spectrum. All of the analysis was determined from the relative magnitudes of the transform of the windowing function. The relative magnitudes will remain in the same proportion even when the signals are multiplied by an amplitude value, so all that must be done to recreate the true measured spectrum is to take the true amplitude value from the spectrum, and then rescale the sum of the rotated and counter-rotated contributions so that they equal the amplitudes exhibited by the measured spectral values. The final result is a highly accurate measure of the true amplitude of the signal at +f₀, so that when the spectrum is reconstructed with the windowing function Ŵ(f) positioned at +f₀, and its mirror-image, complex conjugate pair, Ŵ*(f), placed at −f₀, the resulting sum that includes the interference through the DC bin will be a highly accurate reconstruction of the true, measured signal spectrum.

The above analysis has focused only on the interaction at the +f₀ and −f₀ positions in the spectrum, but a similar analysis can be conducted at any of the affected frequencies to derive an equivalent result. The analysis at the +f₀ and −f₀ positions is most illustrative since the signal is concentrated there, and in practice generally gives the highest signal to noise ratio and most accurate results. To improve the accuracy of the results, the aforedescribed process can be repeated by selecting a frequency proximate to the interfering frequency and by then comparing a quality of fit between the input signal and the reconstructed input signal for consecutive loops through the process.

Turning to FIG. 10, a process for digital rights management during media distribution is provided in flow chart 1000. Particularly, data file 1010 that is desired to be securely transmitted (e.g., a compressed data file such as a compressed audio file) is encrypted with a unique identifier in step 1050. Before the data is encrypted, however, a number of steps may be performed. For example, the data of data file 1010 may be combined with metadata 1020 in step 1030. Such metadata may include, for example, the size of the file, the name of the artist, the name of the song, the length of the song, the link to website of the artist, the link to image data for the albums cover, the compression rate, the file format, and the name of the content provider.

Persons skilled in the art will appreciate that metadata may be added even after the file is encrypted. As such, an encrypted file can be included as data in a larger file that includes metadata. As such a mobile device can determine if the data is desired to be decrypted without actually decrypting the data. For example, if the mobile device has 1 MB of free space in memory and the metadata includes the size of the file then the mobile device can first prompt a user to free space in the memory before decryption if the file size is larger than 1 MB.

Step 1040 can be included to determine the timing and mode of encryption and/or encryption. For example, step 1040 may be initiated with the online purchase of data (e.g., an audio file such as a song). The online content provider can be configured to require information about a customer's mobile device (e.g., the cellular telephone number). The online content provider can then provide this number to an encryption process such that the number can be used to encrypt the file, at step 1050. Alternatively, the number received can be used by the encryption process to retrieve a unique identification from either the mobile device itself (by requesting the identification from the mobile device) or from the service provider for the mobile device. Alternatively still, the mobile device may provide the unique identification that is utilized to encrypt the file.

On the side of the mobile device, the unique identification may be utilized to decrypt the file, at step 1060. Accordingly, only decoders that are provided the unique identification may have the ability to decrypt, and subsequently play, the file.

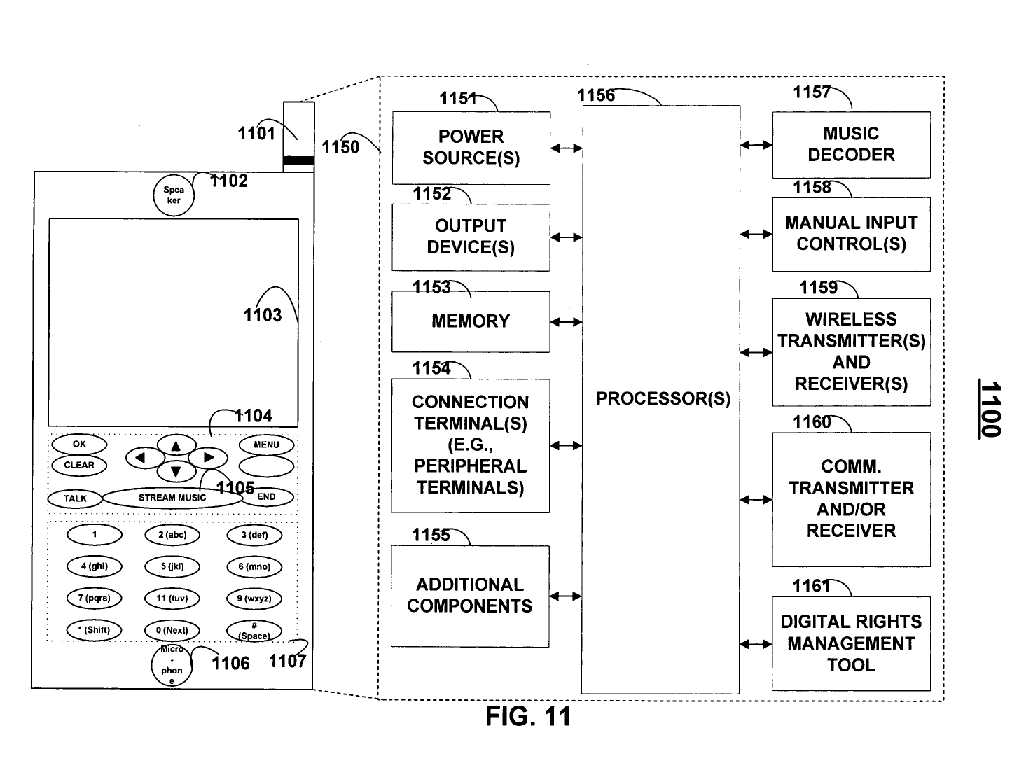

FIG. 11 shows mobile device 1100. Mobile device 1100 may be, for example, a wireless telephone (e.g., cellular telephone), PDA, laptop, Blackberry, Wifi enabled device, WiFiber enable device, infrared device, or any other processing device with a wireless mode of communication. Device 1100 may include receiver 1101, speaker 1102, display screen 1103, input controls 1104 (e.g., audio control 1105), numeric control pad 1107 and microphone 1106. Mobile device 1100 may include controls for utilizing the systems and methods of the present invention. For example, button 1105 may be a button for initiating the delivery of a stream of music. More particularly, button 1150 may be utilized for initiating delivery of a stream of compressed music that may be decompressed by the mobile device and played to the user of device 1100. Button 1105 may alternatively be used, for example, to compress, decompress, and process audio data using the principles herein.

Mobile device 1100 may include architecture 1150. Architecture 1150 may include any number of processors 1156, power sources 1151, output devices 1152, memory 1153, connection terminals 1154, music decoders 1157, manual input controls 1158, wireless transmitters/receivers 1159, other communication transmitters/receivers 1160, or any other additional components 1155. Architecture may also include digital rights management tool 1161. Any of the components of architecture 1150 may be included as hardware or embodied as software. Similarly, mobile device 1100 may be a stationary device (e.g., a home computer). Device 1100 may also include any of the signal compression, decompression, and processing discussed herein. For example, device 1100 may include a chaotic generator such that a compressed signal (e.g., received from a wireless telephone base station) can be decompressed. In this manner, control codes can be removed from the compressed signal, applied to the chaotic generator to provide periodic orbits by stabilizing otherwise unstable aperiodic orbits, and utilized to generate waveforms (e.g., audio waveforms) representative of the data that was compressed (e.g., audio waveforms). Similarly, data can be extracted from the compressed data, at device 1100, that was utilized in any of the processing steps discussed herein and utilized to decompress the compressed data (e.g., data that is indicative of how audio waveforms were modified can be extracted). Similarly, device 1100 can utilize the compression and processing schemes discussed herein to compress data for data transmission (e.g., to a wireless telephone base station).

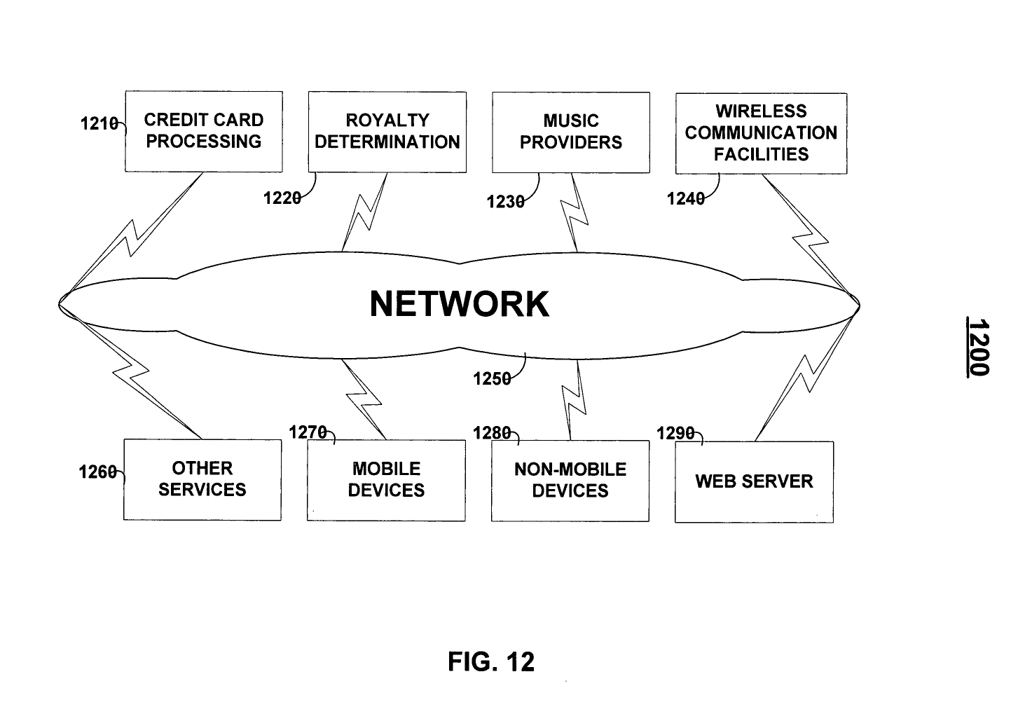

FIG. 12 shows network topology 1200 that may include credit card processing facility 1210, royalty determination facility 1220, music providers or other content providers 1230, wireless communications facilities 1240, mobile devices 1270, non-mobile devices 1280, web-servers 1290 and other components 1260 (e.g., billing integration facility so that wireless purchases are invoiced on the monthly bill from a wireless carrier). Such components of network 1200 can communicate to each other via network 1250 which may be, for example, an intranet, internet, wireless channel, or wire-based channel. Persons skilled in the art will appreciate that audio data (e.g., a song or ringtone) may be pre-compressed or uncompressed (e.g., via a chaotic compression scheme) and stored at content providers 1230. A user may, for example, utilize a wireless device (e.g., a wireless telephone to purchase audio data and may pay using credit card processing facility 1210. A pre-defined percentage, for example, of this sale may be forwarded to royalty determination facility 1220, as a result of communications with royalty determination facility 1220, and distributed to the appropriate entity (e.g., the artist that created the purchased song or the manager of the artist that created the purchased song).

The disclosed CPSE method can also be employed to analyze the phase representation of transient event. In frequency representation of time-domain or spatial-domain signals, it is difficult to develop an accurate approximation of any short-term events that occur in the window of data that is being analyzed. In particular, if the window of data that is being analyzed includes N samples, and if there is a short-duration or short-extent event that is confined primarily to P<N samples (and, generally, P<<N), then the frequency-domain representation of these events tends to be very difficult to approximate. Certain undesirable effects, like the Gibbs phenomenon or ringing effects, may occur whenever the frequency domain representation is truncated. In compressed music a common problem is pre-echo before transient events (with post-echo effects present as well, but less noticeable). A solution is presented to the approximation problem for the phase representation in the frequency domain. When this phase representation is paired with a reasonably accurate magnitude approximation, the resulting transient events are well-localized and quite accurate.

It will be assumed that the transient event can be approximated by two pulses of approximately the same shape, with a separation of 2ρ samples between the pulses, centered around sample γ. Let the pulses have different magnitudes, so set m₂=α*m₁ as the magnitudes of pulse 2 and pulse 1, respectively. Define the frequency domain representation of a single pulse to be of the form r_{β}e^{iθ}^{_{β}}where β represents the frequency variable, e.g. if the Discrete Fourier Transform or the Fast Transform is used, then β represents the frequency bin.

Before solving the phase representation problem for two pulses, it is necessary to point out the structure of the phase representation for a situation where all frequencies coalesce coherently at a signal maximum at a particular point in the time- or spatial-domain. When this occurs, the maximum amplitude single pulse can be achieved for the given set of frequencies. If the pulse is to occur at sample γ in the data window, then the phase representation should be linear and the phase representation as a function of frequency has a slope that is generally of the form

$$\frac{- 2 π}{N} γ$$

This would cause all of the frequency components of the transient signal to have a coherent phase at the sample γ, and the phase relationship that produces coherence at sample γ will be abbreviated as “phase corresponding to sample γ.”

Now, to solve for the phase representation of the two-pulse problem, the frequency domain representation would be the sum of the contributions from pulse 1 and pulse 2. This gives a sum of the form r_{1β}e^{iθ}^{_{1β}}+r_{2β}e^{iθ}^{_{2β}}. If the sum at a single frequency is considered (or in a single bin of a discrete transform), the subscript β can be dropped, and since m₂=α*m₁, it is clear that r_{2β}=αr_{1β}. Next, define a term to represent the phase value corresponding to the sample γ, and call this value \overline{θ}. Now the pulse at sample γ−p would have to have a retarded phase, while the pulse at γ+p would have to be advanced by an equal amount, so we can set θ₁=\overline{θ}+ν and θ₂=\overline{θ}−ν. This gives the sum of the two pulses as

$$ϕ = {tan}^{- 1} ( \frac{1 - α}{1 + α} tan v )$$

This can be put into a magnitude-phase form as

$${r}_{1} \sqrt{1 + {α}^{2} + 2 αcos ( 2 v )} {ⅇ}^{ⅈ ( \overline{θ} + ϕ )}$$

$$where$$

$$ϕ = {tan}^{- 1} ( \frac{1 - α}{1 + α} tan v )$$

and the proper quadrant for the angle can be selected to be consistent with the position of the resultant sum.

Finally, it should be noted that once the two pulses are combined as above, the result can be viewed as a single “virtual” pulse, and can be further combined with a third pulse and the process can be iterated to recreate the representation of a transient event of essentially arbitrary form and extent.

In summary, a compression format and related DRM and transmission methods are provided to optimize transmission of high-quality audio over a broad range of networks. The technology allows the development of a scalable, low complexity format that preserves the full CD bandwidth, and allows transmission over, for example, GPRS networks at 32 Kbps for storage and playback on mobile phones and PDAs. The DRM is seamlessly integrated so that the user never notices its presence unless unauthorized redistribution is attempted, and the DRM permits the music to be streamed so that the user can listen while the download is in progress. Since the signal reconstruction methodology is additive, extra layers can be added to the data stream on networks to provide even higher quality. For broadband distribution, all of the signal components that were detected at the analysis and decomposition stage can be included in the transmission. The end result is a flexible encoding technology enabling users to encode once, but access at any bitrate.

A number of powerful tools have contributed to the development of this flexible model. Among these tools are the Unified Domain representation, Unified Psychoacoustic Model, Cross-Power Spectral (CPSE) analysis, and chaotic cupolet generation. The ability to categorize and aggregate the signal components allows back-end quantization and lossless compression techniques that do not interfere with the capability of accessing the different layers in the file.

Persons skilled in the art will also appreciate that the present invention is not limited only to the embodiments described. Instead, the present invention more generally involves pre-processing and compressing data. As a result, image data for video or pictures, or any other type of content, can be processed and compressed utilizing, for example, the process of flow chart 200 of FIG. 2. All such modifications are within the scope of the present invention, which is limited only by the claims that follow:

What is claimed is:

1. A method for determining at least one dominant frequency of an input signal, comprising:
(a) sampling the input signal with a predetermined sampling rate, said sampling rate defining a bin in frequency space;
(b) transforming the sampled input signal into a unified signal;
(c) windowing the unified signal with a first window and a second window, with the second window having a time delay relative to the first window;
(d) computing a first frequency transform of the unified signal windowed with the first window and a second frequency transform of the unified signal windowed with the second window.
(e) determining a phase angle between the first frequency transform and the complex conjugate of the second frequency transform; and
(f) calculating from the phase angle the at least one dominant frequency.

2. The method of claim 1, wherein the calculated at least one dominant frequency is resolved with a fraction of a bin size.

3. The method of claim 2, wherein the fraction is less than 0.01 of the bin size.

4. The method of claim 2, wherein the fraction is less than 0.001 of the bin size.

5. The method of claim 1, wherein the input signal is an audio signal.

6. The method of claim 5, wherein the audio signal is a single channel or multi-channel audio signal.

7. The method of claim 1, wherein the input signal comprises a speech or music signal.

8. The method of claim 1, further comprising remapping spectral regions away from a spectral peak to a nearest dominant spectral peak.

9. The method of claim 1, further comprising separating oscillatory and noise-like signal components from the unified signal based on the determined at least one dominant frequency.

10. The method of claim 9, further comprising applying a psychoacoustic model to prioritize at least the oscillatory signal components.

11. The method of claim 10, further comprising assigning at least the oscillatory signal components to a plurality of layers based on the prioritization.

12. The method of claim 11, further comprising transmitting from the plurality of layers those layers with a required bitrate not exceeding an available transmission bitrate.

13. The method of claim 1, wherein the at least one dominant frequency is associated with at least one waveform produced by a chaotic signal generator.

14. The method of claim 13, further comprising associating a control signal with the at least one waveform, wherein the control signal induces a chaotic system to assume periodic orbits that reproduce the at least one waveform.

15. A method for reconstructing an input signal having a dominant frequency determined according to claim 1, said dominant frequency different from a center frequency of a bin in frequency space, comprising:
(g) determining a magnitude of a frequency transform of the input signal at a selected bin close to the dominant frequency;
(h) frequency-shifting an analysis window by a difference between the dominant frequency and a center frequency of the selected bin;
(i) scaling the determined magnitude at the selected bin with an inverse of the frequency-shifted analysis window to compute a signal magnitude at the dominant frequency; and
(j) determining a phase shift between the frequency-shifted analysis window and the input signal at the selected bin to reconstruct the input signal.

16. A method for transmitting a signal with adaptable transmission bitrate, comprising:
(a) prioritizing oscillatory and noise components of a signal;
(b) compressing said oscillatory and noise components into a plurality of layers based on said prioritization;
(c) if an available transmission bandwidth is insufficient to transmit each layer of the plurality of layers, selecting for transmission a subset of the plurality of layers; and
(d) transmitting said subset of layers.

17. The method of claim 16, wherein said subset includes layers having a greater psychoacoustic significance.

18. The method of claim 16, further comprising determining a change in the available transmission bandwidth and dynamically adjusting selection of the subset of layers.

19. The method of claim 16, further comprising reconstructing the signal from the layers in a transmitted subset based on an authorization.

20. A method for determining spectral content of an input signal having interfering frequency components, comprising:
(a) sampling the input signal and applying a window function;
(b) computing a frequency transform of the windowed input signal and determining a phase of the interfering frequency components;
(c) determining a combined normalized magnitude of the interfering frequency components;
(d) resealing the combined normalized magnitude and phase to match an observed magnitude and phase of the interfering frequency components; and
(e) reconstructing the input signal from the rescaled magnitude and phase.

21. The method of claim 20, wherein the interfering frequency components comprise a self-interfering signal component having a frequency significantly lower than an effective sampling rate.

22. The method of claim 21, wherein the self-interfering signal component has a frequency close to DC.

23. The method of claim 20, further comprising repeating steps (b) through (e) with a frequency proximate to the interfering frequency and comparing a quality of fit between the input signal and the reconstructed input signal for consecutive matches.
